(19) United States
(12) Patent Application Publication
(10) Pub. No.: US 2016/0378192 A1
(43) Pub. Date: Dec. 29, 2016

(54) DEVICE AND METHOD OF OPERATING A CONTROLLABLE ELECTRONIC DEVICE

(71) Applicant: Intel IP Corporation, Santa Clara, CA (US)

(72) Inventor: Lei Zhang, Aix en Provence (FR)

(21) Appl. No.: 14/748,314

(22) Filed: Jun. 24, 2015

(51) Int. Cl. G06F 3/01; G06F 3/0485; H04B 5/00

(52) U.S. Cl. CPC G06F 3/017; H04B 5/0031; G06F 3/0485

(57) ABSTRACT

A device may include a near field communication antenna, a monitor, a comparator, and a trigger. The near field communication antenna may be configured to detect an external near field communication device. The monitor may be configured to monitor a series of one or more transitions in a detection state of the device between a first detection state and a second detection state based on whether the near field communication antenna detects the near field communication device. The comparator may be configured to perform a comparison between first timing information associated with the series of one or more transitions and second timing information associated with a first predefined series of one or more transitions. The trigger may be configured to initiate a predefined action of the device based on the comparison.

### TECHNICAL FIELD

Various embodiments relate generally to a device and a method operating a controllable electronic device.

### BACKGROUND

Conventional smart devices, such as e.g. smartphones and tablets, primarily utilize virtual and physical buttons in order to enable a user to control the smart device. For example, a user may trigger different operations of a smart device such as “return/back”, “return to home screen”, “list recent activities/task” by pressing one or more buttons. A number of separate buttons are traditionally utilized to individually trigger each corresponding operation, such as a “home button” for triggering a return to home screen or a “back button” for returning to a previous screen. Sequences of button presses may also be predefined in order to trigger an operation of the smart device, such as pressing virtual buttons on one or more displayed menu screens in order to navigate through virtual screens of a smart device and to trigger one or more related operations.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

FIG. 1 shows an exemplary near field communication (NFC) accessory;

FIG. 2 shows various components and circuits of an NFC-enabled smart device and an NFC accessory;

FIG. 3 shows a flow diagram illustrating an NFC-based smart device control process;

FIG. 4 shows a flow diagram further illustrating the NFC-based smart device control process of FIG. 3;

FIG. 5 shows a digital waveform representations of a number of NFC accessory movements;

FIG. 6 shows positioning scenarios of an NFC accessory relative to an NFC-enabled smart device;

FIG. 7 shows several digital waveforms illustrating an active-delay mechanism for NFC-based smart device control;

FIG. 8 shows a flow diagram illustrating a further NFC-based smart device control process using an active-delay mechanism;

FIG. 9 shows a flow diagram illustrating a method for controlling an NFC-enabled smart device according to an aspect of the disclosure;

FIG. 10 shows a flow diagram illustrating a method for controlling a smart device according to a further aspect of the disclosure;

FIG. 11 shows a block diagram illustrating internal components of core hardware of a smart device; and

FIG. 12 shows a flow diagram illustrating a method for operating a controllable electronic device.

### DESCRIPTION

The following detailed description refers to the accompanying drawings that show, by way of illustration, specific details and embodiments in which the invention may be practiced.

The word “exemplary” is used herein to mean “serving as an example, instance, or illustration”. Any embodiment or design described herein as “exemplary” is not necessarily to be construed as preferred or advantageous over other embodiments or designs.

As used herein, a “circuit” may be understood as any kind of a logic implementing entity, which may be special purpose circuitry or a processor executing software stored in a memory, firmware, or any combination thereof. Furthermore, a “circuit” may be a hard-wired logic circuit or a programmable logic circuit such as a programmable processor, for example a microprocessor (for example a Complex Instruction Set Computer (CISC) processor or a Reduced Instruction Set Computer (RISC) processor). A “circuit” may also be a processor executing software, for example any kind of computer program, for example a computer program using a virtual machine code such as for example Java. Any other kind of implementation of the respective functions which will be described in more detail below may also be understood as a “circuit”. It may also be understood that any two (or more) of the described circuits may be combined into one circuit.

The incorporation of Near Field Communication (NFC) technology has become commonplace in many new smart phone and tablet products. This NFC technology has been conventionally deployed to exchange basic data between two NFC terminals, such as between an NFC-enabled smart device and an NFC accessory, such as e.g. a ring, key fob, wearable device with an NFC inlay, or other similar NFC accessories. Such NFC accessories may be conventionally used to trigger an operation on a smart device, such as initiating a phone call to a preselected contact, enabling external services such as e.g. Wireless Fidelity (WiFi) or Bluetooth, or locking a device. For example, a user may position an NFC accessory within the NFC field range of an NFC-enabled smart device. The NFC-enabled smart device may identify the NFC accessory (such as by reading identification information or other stored data provided wirelessly by the NFC accessory over), and may trigger a predefined smart device operation upon identification of an eligible NFC accessory. A user may thus predefine a smart device to execute a selected operation in response to identifying a certain NFC accessory, and may even program a smart device to execute a different operation in response to identification of each of a number of different NFC accessories.

However, these conventional use cases for NFC accessories and NFC-enabled smart devices may be limited by the detection of static content of an NFC accessory. In other words, current NFC-enabled smart devices may simply identify the presence of a recognized NFC accessory and trigger a single predefined operation. It may thus not be possible to perform different operations with a single NFC accessory without re-programming the NFC smart device every time to perform a different operation in response to a subsequent detection of the NFC accessory. The degree of control offered by existing NFC use cases is therefore limited.

Accordingly, it may be desirable to dynamically expand the capability of NFC interactions between NFC-enabled devices (e.g. an NFC-enabled smart device and NFC accessory) by allowing a single NFC accessory to trigger multiple different operations of a proximate NFC-enabled smart device, such as e.g. by detecting spatial movements of an NFC accessory relative to an NFC-enabled smart device.

Such an improvement may be particularly desirable in providing a degree of control to a user for operating a smart device. As previously detailed, smart devices are conventionally controlled by button press(es), such as either physical buttons distributed on the surface of a smart device or virtual buttons displayed on an interactive display screen. Due to the spatial distribution of buttons across the smart device, it may be unnecessarily inconvenient for a user to control a smart device with a single hand. This problem may be accentuated for the use of larger devices, such as tablets and larger smartphones, where re-handling of the smart device or use of two hands may be necessary in order for a user to access the desired buttons. Furthermore, certain buttons such as the “home button” or “function button” may be utilized by a user at a substantially high rate, which may potentially lead to potential damage due to over-usage.

Accordingly, it may be possible to provide an enhanced user experience by offering the user with an alternative method to control a smart device in the form of enhanced NFC-based smart device control. While the above-detailed existing NFC-based approaches may be used to trigger certain smart device operations, the use cases are severely limited. In particular, conventional NFC-based smart device control only allows a single smart device operation to be programmed to an NFC accessory at one time, and accordingly a single NFC accessory may only be capable of triggering a single operation of an NFC-enabled smart device. A user may thus need to re-program an NFC device every time to perform a different operation in response to the same NFC accessory, which may severely restrict the usefulness of NFC-based smart device control.

In contrast, NFC-based smart device control may utilize timing information associated with detection of an NFC accessory by an NFC-enabled smart device in order to recognize different spatial movement patterns of the NFC accessory relative to the NFC-enabled smart device. In doing so, an NFC-enabled smart device may be capable of triggering a variety of different movements by detecting distinct spatial movement patterns, herein also referred to as NFC movements, of a proximate NFC accessory.

NFC-enabled smart devices may conventionally operate by constantly monitoring for the presence of NFC-enabled devices such as NFC accessories. NFC-enabled smart devices may thus have a finite NFC field range that dictates how proximate an NFC accessory must be in order to be successfully detected by the NFC-enabled smart device. An NFC-enabled smart device may detect the presence of an NFC accessory that has entered the detection range, and may proceed to identify the detected NFC accessory, such as by extracting NFC identification information from an NFC signal received from the detected NFC accessory. The NFC-enabled smart device may then compare the identity of the detected NFC accessory to a database in order to determine whether an operation has been associated with the detected NFC accessory and may proceed to perform an associated operation in the event that an operation has been previously associated with the detected NFC accessory.

Existing NFC-based smart device control approaches may thus be based solely on identifying whether or not a predefined NFC accessory is in range, and performing a single operation associated with identification information of the NFC accessory if the NFC accessory is in range. In contrast, an improved NFC-enabled smart device may be configured to assess the timing associated with the detection of an NFC accessory. In other words, the temporal variance of an NFC accessory between a detected state (i.e. within the detection range of an NFC-enabled smart device) and an undetected state (i.e. out of range of an NFC-enabled smart device) caused by the user moving the NFC accessory may be used to trigger one or more different operations of the smart device.

An NFC-enabled smart device may monitor the varying NFC detection state (i.e. detected or undetected) of an NFC accessory in terms of time in order to recognize a variety of spatial movement patterns, referred to herein as either “NFC movements” or simply “movements”. These movements may be characterized by timing information associated with state changes in detection state, such as by one or more timestamps indicating detected or undetected state. The NFC-enabled smart device may then trigger a variety of different operations based on the particular detected movement of the NFC accessory. In this manner, a user may be able to control an NFC-enabled smart device with an NFC accessory to perform a variety of different operations, thus offering a distinct advantage over the existing NFC use cases that may only support a single operation per NFC accessory. A user may thus be given greater control over an NFC-enabled smart device while reducing the number of operations that explicitly require a button press, thereby contributing to an improved user experience.

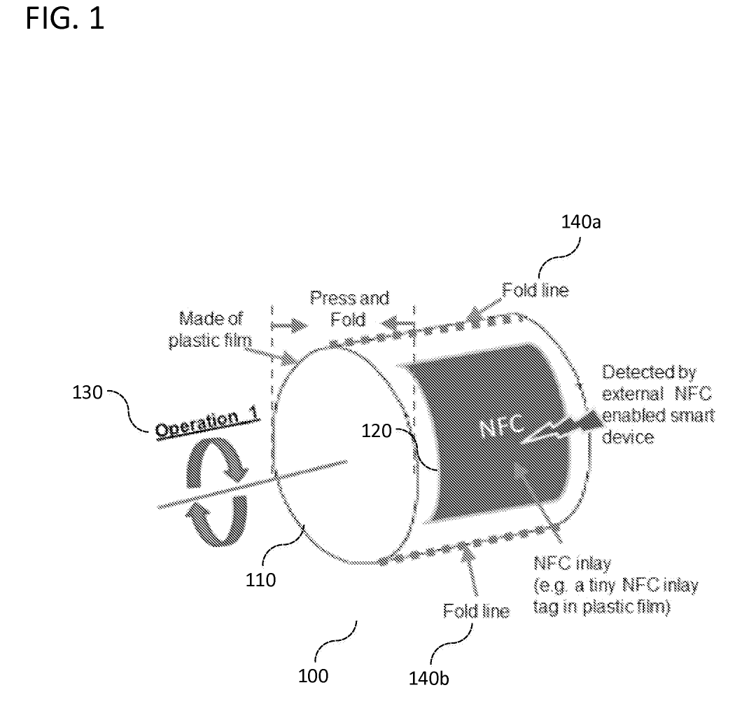

FIG. 1 shows an exemplary NFC accessory 100. As shown in FIG. 1, NFC accessory 100 may be formed in the shape of a ring and be made of material 110, which may be light and foldable, such as e.g. plastic film. NFC accessory 100 may be provided with NFC inlay 120, which may integrated into material 110 and may be detectable by an external NFC-enabled smart device using NFC signaling. NFC accessory 100 may be worn on a fingertip or middle part of a user's finger. A proximate NFC-enabled smart device may detect NFC inlay 120 if the user positions their finger within the NFC field range of the proximate NFC-enabled smart device, and may subsequently attempt to identify NFC accessory 100 based on identification information provided by NFC inlay 120. An NFC-enabled device may detect the absence of NFC accessory 100, i.e. be aware of the absence of NFC accessory 100, if a user wearing NFC accessory 100 moves their finger out of the NFC field range.

An NFC-enabled smart device may accordingly be in either NFC_Detection_Active state or NFC_Detection_Inactive state based on whether or not an NFC accessory, such as NFC accessory 100, is within the NFC field range of an NFC-enabled smart device following certain spatial movements of NFC accessory 100 relative to an NFC-enabled device, e.g. according to the movement of a user's finger equipped with NFC accessory 100. The NFC detection state of an NFC-enabled smart device may vary from NFC_Detection_Inactive to NFC_Detection_Active, and then back to NFC_Detection_Inactive state as the user moves NFC accessory 100 into and out of the NFC field range, such as e.g. with finger movements.

A user may typically hold their forefinger near the back of a smart device, and may be free to move their forefinger along the back of the smart device in addition to bending and unbending their forefinger, thereby bringing their finger closer to and further away from the back of a smart device. A user may therefore utilize such finger movements to make NFC accessory 100 enter or exit the NFC field range of an NFC-enabled smart device, i.e. move NFC accessory 100 into and out of the NFC field range of an NFC-enabled smart device, which as a result may trigger NFC_Detection_Active or NFC_Detection_Inactive state of the NFC-enabled smart device. Different sequences of NFC_Detection_Active and NFC_Detection_Inactive state, defined by timing information (such as e.g. timestamps) representing state transitions, may then be captured by an NFC-enabled smart device and used to trigger a pre-defined smart device operation.

NFC accessory 100 may be rotated on a user's figure (shown as shown by Operation_1 130) in order to alter the emitted NFC field strength by NFC accessory 100. For example, a user may increase the emitted NFC field strength relative to a proximate NFC-enabled smart device by rotating their finger such that NFC inlay 120 is closer to and/or facing an NFC antenna provided on the NFC-enabled smart device. NFC accessory 100 may be more easily detected by the NFC-enabled smart device when in this position, and accordingly the NFC-enabled smart device may be more prone to detect NFC accessory 100 and enter NFC_Detection_Active state. Similarly, a user may rotate NFC accessory 100 on their finger to be turned sideways relative to the NFC field associated with the NFC antenna provided on the NFC-enabled smart device in order to make NFC accessory 100 less prone for detection by the NFC-enabled smart device, and thus more likely for the NFC-enabled smart device to be in NFC_Detection_Inactive state.

NFC accessory 100 may be folded along the fold lines 140a and 140b, such as to prepare NFC accessory 100 for storage. The thickness of NFC accessory 100 may be substantially negligible when folded, and thus may be easily stored in a wallet, pocket, desk, or even in a dedicated slot on a smart device similar to those provided for styluses.

The detection state of NFC accessory 100 relative to a proximate NFC-enabled smart device may vary based on the position of NFC accessory 100 relative to the NFC-enabled smart device. NFC-enabled smart devices may constantly monitor for NFC accessories within NFC field range, and subsequently may determine if an NFC accessory is within NFC field range or outside of NFC field range.

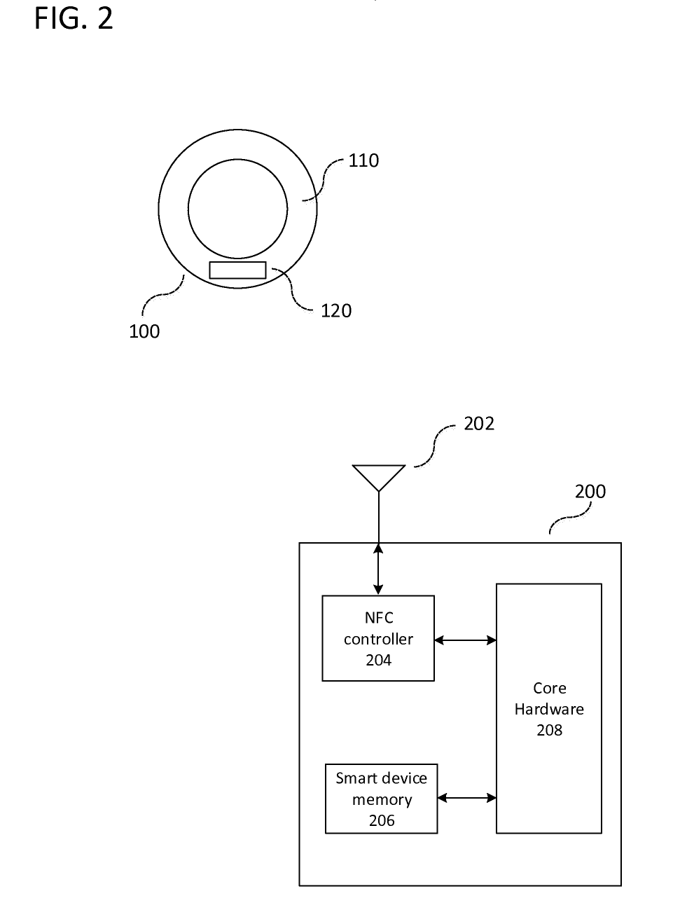

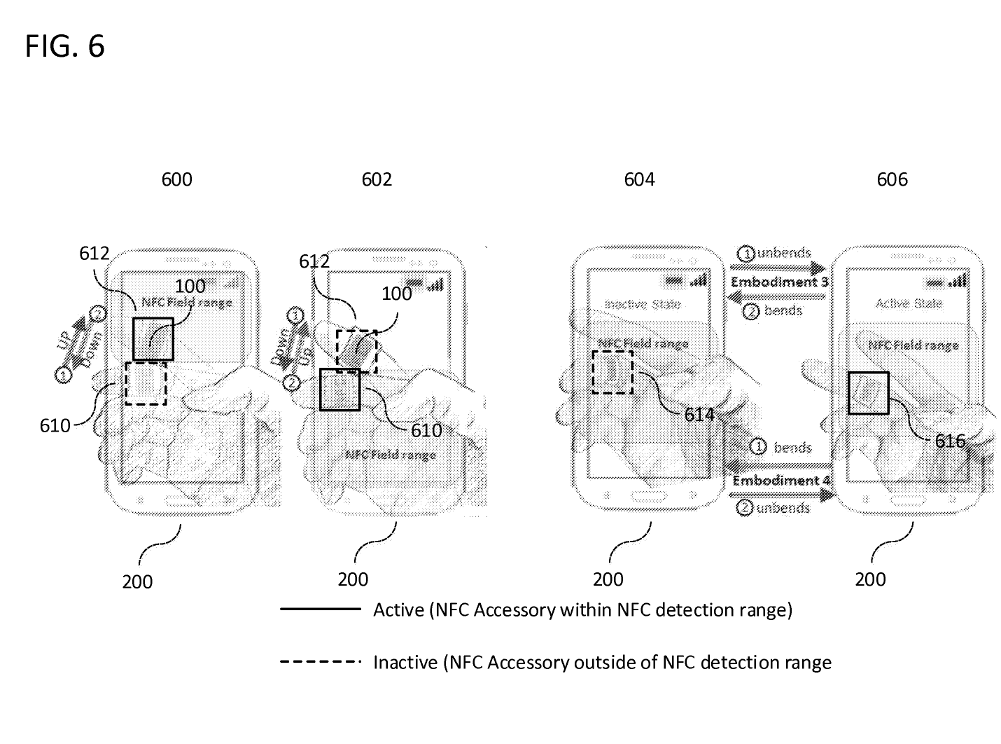

FIG. 2 illustrates an exemplary scenario in which NFC accessory 100 is proximate to smart device 200. It is appreciated that the illustrated spatial positioning of NFC accessory 100 relative to smart device 200 is exemplary, and that NFC accessory 100 may conventionally be located along the back of smart device 200 (as will be described regarding FIG. 6). Smart device 200 may be NFC-enabled, and may be e.g. a smartphone or a tablet. Smart device 200 may include NFC antenna 202, NFC controller 204, smart device memory 206, and core hardware 208. The aforementioned circuitry and hardware (such as NFC controller 204, smart device memory 206, and core hardware 208) may be implemented as separated circuits, e.g. such as separate integrated circuits as illustrated in FIG. 2. It is understood that some or all of the circuits may be implemented by a common programmable processor, such as e.g. a microprocessor. Accordingly, some or all of the functionality of the one or more aforementioned circuitry may be consolidated into a single hardware component. It is also understood that smart device 200 may include a number of additional components, including hardware, processors, memory, and other specialty or generic hardware/processors/circuits, etc., in order to support a variety of additional operations of wireless radio communications. Smart device 200 may also include a variety of user input/output devices such as displays, keypads, touchscreens, speakers, external buttons, etc.

Smart device 200 may be provided with NFC-dedicated components NFC antenna 202 and NFC controller 204 in order to support NFC functionality. In addition to the aforementioned NFC-specific components, smart device 200 may be provided with core hardware 208 in order to support various functionalities associated with conventional smart device operation, such as executing software components and applications, accepting inputted user data, providing a user with multimedia content, etc. Core hardware 208 may thus be e.g. a core central processing unit (CPU) responsible for a substantial degree of control over smart device 200. Smart device 200 may be provided with one or more additional antennas or antenna arrays, such as antennas for transmission and/or reception of wireless radio signals associated with cellular communications or other radio access networks. As shown in FIG. 2, NFC controller 204 is capable of interacting with core hardware 208.

As will be described, smart device 200 may therefore include a near field communication antenna (antenna 202) configured to detect an external near field communication device. Smart device 200 may also include a processor (core hardware 208) configured to pilot NFC controller 204 to detect a change in detection state of the smart device from a first detection state to a second detection state, wherein the change in detection state of the smart device is based on whether the near field communication antenna detects the external near field communication device, determine a duration of a first time period during which the smart device remains in the second detection state, and trigger a predefined action of the smart device based on at least the duration of the first time period. Smart device 200 may additionally a memory (NFC smart device memory 206).

In another aspect of the disclosure, the processor (core hardware 208) may be configured to monitor a series of one or more transitions in a detection state of the smart device between a first detection state and a second detection state based on whether the near field communication antenna detects the near field communication device, perform a comparison between first timing information associated with the series of one or more transitions and second timing information associated with predefined series of one or more transitions, and trigger a predefined action of the smart device based on the comparison. As will be described, the first and second timing information may be based on e.g. timestamps or durations of time.

In a further aspect of the disclosure, the processor (NFC controller 204) may be configured to detect a transition in detection state of the smart device from a first detection state to a second detection state, wherein the detection state of the smart device is based on whether the near field communication antenna detects the external near field communication device, control the smart device to operate according to a first operation mode during a first time period before the transition in which the smart device remains in the first detection state, and control the smart device to operate according to a second operation mode during a second time period after the transition once the smart device transitions from the first detection state to the second detection state. As will be described, the first operation mode and the second operation mode may be a predefined operation mode of the smart device, such as e.g. text entry modes, virtual window scrolling modes, and/or copy/paste modes.

Smart device 200 may thus be capable of interacting with NFC accessories such as NFC accessory 100 using NFC antenna 202, NFC controller 204, and smart device memory 206. For example, NFC controller 204 may be configured to detect the presence of NFC accessory 100 within NFC field range using NFC antenna 202. As previously detailed, NFC controller 204 may be configured to interact with core hardware 208. Core hardware 208 may thus be configured to interact with NFC controller 204 in order to monitor whether or not NFC controller 204 detects an NFC accessory such as NFC accessory 100.

For example, core hardware 208 may be configured to execute software, such as e.g. software stored in smart device memory 206. Core hardware 208 may thus be configured to execute one or more software routines based on NFC applications, which may e.g. include software routines configured to interact with NFC controller 204 to control various operations of smart device 200 based on whether NFC controller 204 detects the presence of an NFC accessory such as e.g. NFC accessory 100.

Core hardware 208 may thus be configured interact with NFC controller 204 in order to determine whether or not NFC controller 204 detects an NFC accessory, such as e.g. according to one or more software routines stored in smart device memory 206. Core hardware 208 may additionally be configured to determine timing information associated with changes in detection state of an NFC accessory in addition to identification information of a detected NFC accessory through interactions with NFC controller 204. It is appreciated that such functionality involving timing and identification information determination may be implemented in a number of different ways, such as by determining timing and/or identification information solely in NFC controller 204 and providing such information to core hardware 208. Alternatively, such functionality may be implemented in part by both NFC controller 204 and core hardware 208, or may be substantially implemented in core hardware 208 based on raw information provided by NFC controller 204.

Core hardware 208 may thus determine an NFC detection state based on the data/responses received from NFC controller 204, such as data indicating whether or not NFC accessory 100 is within NFC field range, i.e. is detected by NFC controller 204. Core hardware 208 then may enter NFC_Detection_Active state if NFC controller 204 indicates that NFC accessory 100 is within NFC field range, i.e. is detectable, which may be on a software level as executed by core hardware 208. Core hardware 208 may additionally be configured to determine a point in time in which NFC accessory 100 enters NFC field range, such as e.g. a time stamp or similar timing information, which may be based on data provided by NFC controller 204.

Similarly, core hardware 208 may be able to determine if NFC accessory 100 is outside of NFC field range based on data/responses received from NFC controller 204. Core hardware 208 may additionally be able to determine a point in time when NFC accessory 100 exits NFC field range after being within NFC field range, which may be e.g. in the form of a timestamp and similarly based on data received from NFC controller 204. Core hardware 208 may then enter NFC_Detection_Inactive state, which as previously detailed regarding NFC_Detection_Active state may be on a software level as executed by core hardware 208.

It is appreciated that for purposes of explanation, smart device 200 may similarly be considered to in NFC_Detection_Active or NFC_Detection_Inactive state in accordance with detection state held by core hardware 208 at a given point in time. It is thus understood that references to smart device 200 being in a particular detection state corresponds to core hardware 208 also being in the same particular detection state, such as e.g. dictated on a software level within core hardware 208. Similarly, it is understood that references to core hardware 208 being in a particular detection state corresponds to smart device 200 also being in the same particular detection state.

Likewise, it is appreciated that references to smart device 200 performing a particular operation refer to core hardware 208 performing the particular operation, such as by executing one or more software routines to perform the particular operation.

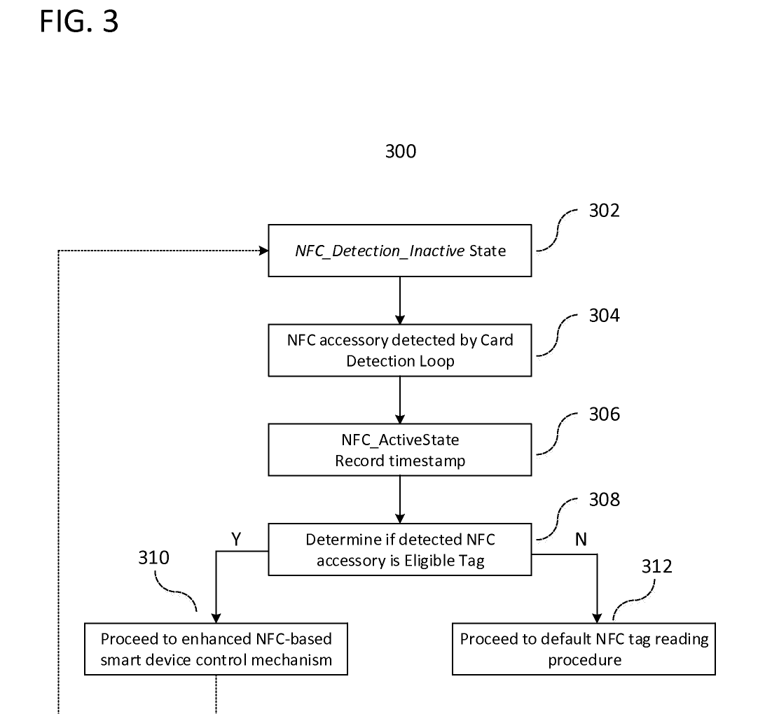

FIG. 3 illustrates an exemplary process 300 which smart device 200 may execute. As previously detailed, smart device 200 may include NFC controller 204 and core hardware 208, which in conjunction may be configured to control detection, identification, and communication with NFC devices. Smart device 200 may begin in NFC_Detection_Inactive state in 302. NFC controller 204 may be in an “NFC polling mode” and enable an “NFC Card Detection Loop” to detect precisely when an NFC accessory, such as NFC accessory 100, enters the NFC field range of the smart device 200. The NFC Card Detection Loop may be implemented at a firmware level within NFC controller 204, and may be configured by the original equipment manufacturer of smart device 200. The NFC Card Detection Loop may operate on a millisecond scale, such as 50 ms or 100 ms, which may be configurable via an upper software level such as an Application Program Interface (API).

NFC accessory 100 may move into NFC field range of smart device 200, such as e.g. due to a user performing a finger movement with a finger equipped with NFC accessory 100. For example, the user may slide their finger equipped with NFC accessory 100 from an initial location outside of NFC field range to another location inside of NFC field range. Alternatively, the user may straighten their finger from a bent position such that NFC accessory 100 moves from an initial location outside of NFC field range to another location inside of NFC field range. NFC controller 204 may thus be able to detect an NFC signal emitted from NFC inlay 120 of NFC accessory 100, and thus may detect the NFC accessory in 304 of method 300. NFC controller 204 may then exchange an initial command/answer (i.e. NFC Technology detection phase, Collision resolution phase, and Activation phase) with NFC accessory 100. Smart device 200 may then enter into NFC_Detection_Active state in 306 by receiving a notification from the firmware layer (i.e. Activate Notification), and may record a timestamp signifying the point in time which NFC accessory 100 was detected by smart device 200, which may e.g. be executed by core hardware 208. The timestamp may thus indicate the time during which NFC device 200 entered NFC_Detection_Active state, and may accordingly be used by core hardware 208 to identify user movements of NFC accessory 100 in order to trigger a variety of smart device operations.

In contrast to conventional use cases for NFC, smart device 200 may be configured to trigger multiple operations with a single NFC accessory without constant re-programming. However, smart device 200 may additionally be configured to support the aforementioned conventional use cases for NFC in addition to the enhanced NFC-based smart device control described herein.

Smart device 200 may rely on identification information in order to determine whether to operate according to the conventional NFC use cases or according to enhanced NFC-based smart device control. After entering NFC_Detection_Active state and recording a timestamp to indicate entry into NFC_Detection_Active state, smart device 200 may attempt to identify NFC accessory 100 by reading information provided by NFC accessory 100, which may be e.g. performed by NFC controller 204. For example, NFC controller 204 may read the Unique Identification Number (UID) provided by NFC accessory 100, such as e.g. from a memory provided in NFC inlay 120. NFC controller 204 may additionally read block data provided by NFC accessory 100 or may read an NFC Data Exchange Format (NDEF) message provided by NFC accessory 100. NFC controller 204 may be configured to determine which information provided by NFC accessory 100 should be read, and may then perform the associated reading operation in several milliseconds. NFC controller 204 may then proceed to determine whether or not NFC accessory 100 has been pre-configured to operate according to enhanced NFC-based smart device control protocols in 308. 308 may thus include determining if NFC accessory 100 is an Eligible Tag (i.e. eligible NFC accessory), i.e. has been pre-configured to trigger enhanced NFC-based smart device control. If NFC accessory 100 is an Eligible Tag, method 300 may proceed to enhanced NFC-based smart device control mechanism in 310, i.e. may proceed to implement smart device control based on NFC movements according to aspects of this disclosure provided herein. If NFC accessory 100 is not an Eligible Tag, method 300 may instead proceed to default NFC tag reading procedure in 312. Default NFC tag reading procedure may include the aforementioned conventional NFC accessory protocols, such as e.g. triggering a single smart device operation based on the identity of NFC accessory 100 or a normal NFC tag-reading procedure as implemented in conventional Android systems.

The proposed enhanced NFC-based smart device control mechanism of 310 may therefore not interfere with existing NFC-based solutions, such as normal NFC tag reading or the triggering of a single smart device operation based on the identity of a detected NFC accessory. If the detected NFC accessory has been preconfigured for enhanced NFC-based smart device control (such as e.g. by a user, vendor, manufacturer, etc.), the detection and identification of an eligible NFC accessory (i.e. the NFC accessory is an Eligible Tag) may trigger enhanced NFC-based smart device control. Otherwise, default NFC protocols may instead be performed, such as default reading of NFC tag information and any other configured operations.

As depicted in FIG. 3, method 300 may be implemented in a repetitive manner. After smart device 200 has executed the enhanced NFC-based smart device control mechanism in 310, method 300 may return to NFC_Detection_Inactive state in 302.

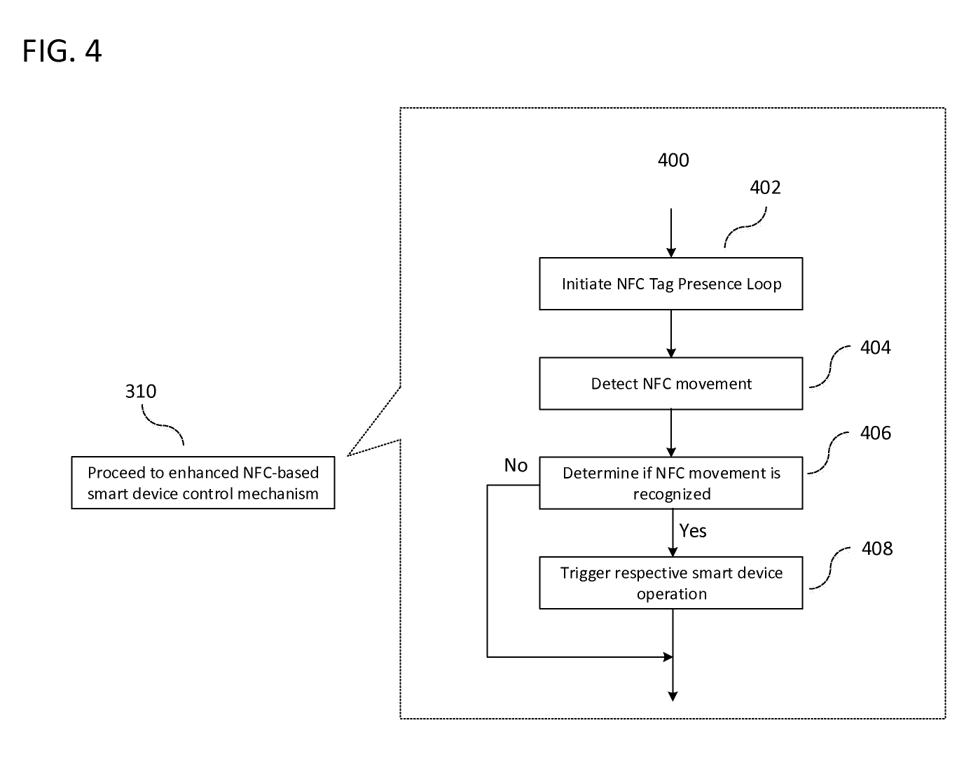

FIG. 4 shows method 400 detailing enhanced NFC-based smart device control according an aspect of the disclosure. As detailed regarding method 300, NFC controller 204 of smart device 200 may detect the presence of an NFC accessory such as NFC accessory 100 within the NFC field range of smart device 200. NFC controller 204 may identify NFC accessory 100 based on emitted NFC information, and may then determine whether or not NFC accessory 100 is an Eligible Tag and should be interacted with according to enhanced NFC-based smart device control protocols, such as in 310 of method 300. As indicated in FIG. 4, it is appreciated that method 400 may be executed as part or all of the enhanced NFC-based smart device control mechanism of 310 in method 300.

If NFC accessory 100 is an Eligible Tag (i.e. as determined in 308 and 310 of method 300), NFC controller 204 may proceed according to method 400. Smart device 200 may initiate NFC Tag Presence Loop 402 via NFC controller 204, during which smart device 200 may continuously monitor whether or not NFC accessory 100 remains within the NFC field range of smart device 200 as detected by NFC controller 204. NFC Tag Presence Loop 402 may be implemented at a software level (e.g. a framework layer in an Android operating system), and may have a loop interval configurable in an order of milliseconds, such as e.g. 60, 80, or 125 ms.

By monitoring whether NFC accessory 100 is within NFC field range, NFC Tag Presence Loop 402 may detect NFC movements based on timing information. Smart device 200 may record a timestamp each time NFC accessory 100 either exits or re-enters NFC field range, thereby triggering NFC controller 204 to be in NFC_Detection_Active state (NFC accessory 100 within range) or NFC_Detection_Inactive state (NFC accessory 100 out of range). A series of timestamps associated with NFC_Detection_Active and NFC_Detection_Inactive state may be utilized to represent an NFC movement. The initial timestamp recorded in 306 of method 300 may also be utilized as a movement timestamp. NFC controller 200 may then compare the series of timestamps representing a performed user movement to one or more predefined series of timestamps representing predefined user movements. NFC controller 200 may then determine whether the series of timestamps matches with one of the predefined series of timestamps, and may perform a predefined action associated with the represented predefined user movement.

A user may therefore define NFC movements composed of time periods in which NFC accessory 100 is within NFC field range of smart device 200 and in which NFC accessory 100 is outside of NFC field range, and may assign a specific smart device operation to each NFC movement. A user may then perform the associated movement by moving NFC accessory 100 into and out of NFC field range of smart device 200 in a manner that matches to one of the predefined movements in order to trigger an associated operation of smart device 200. As numerous different movements can be made with a single NFC accessory, each NFC accessory can be utilized to trigger a plurality of different movements. Unlike conventional NFC-based smart device control, a user may be able to exert greater control over smart device 200 without the use of conventional buttons.

Smart device 200 may therefore detect an NFC movement in 404 by recording timestamps in which NFC accessory 100 moves into NFC field range (triggering NFC_Detection_Active state) and out of NFC field range (triggering NFC_Detection_Inactive state). Smart device 200 may determine if the NFC movement is recognized based on the recorded timestamps, i.e. if the performed NFC movement matches a preconfigured/preprogrammed NFC movement based on the recorded timestamps. Smart device 200 may determine if the NFC movement is recognized by comparing the NFC movement to a database of NFC movements, such as stored in smart device memory 206 of smart device 200.

It is appreciated that the aforementioned database of NFC movements may be implemented by smart device 200 in a variety of alternate manners, such as a waveform database, movement database, time stamp data base, time duration/window database, etc. It is thus appreciated that numerous approaches to compare detected NFC movements to the database of NFC movements may be similarly available and accordingly embraced herein by this disclosure. It is understood that substantially all such movement comparison approaches may involve a certain degree of comparison of timing information, especially a duration of time as manifested by any plurality of points of time, due to the inherent relationship all temporal time waveforms have with time.

Smart device 200 may be configured to recognize NFC movements by comparing timing characteristics of a detected NFC movement to one or more predefined NFC movements. As previously detailed, smart device 200 may record timestamps, e.g. as performed by core hardware 208 via one or more software levels based on data provided by NFC controller 204, indicated NFC_Detection_Active and NFC_Detection_Inactive state. Smart device 200 may then compare the recorded timestamps to a database of predefined NFC movements, where each of the predefined NFC movements is also associated with one or more timestamps. Smart device 200 may calculate a duration of time in which NFC accessory 100 is within NFC field range (NFC_Detection_Active) or calculate a duration of time in which the NFC accessory 100 is outside of NFC field range (NFC_Detection_Inactive), such as based on the recorded timestamps, and may then compare the calculated duration of time to durations of time associated with the predefined NFC movements. It is appreciated that such a “duration” as used herein may additionally include comparing two distinct points in time, as a duration in time inherently exists between two such points. Smart device 200 may therefore determine if the NFC movement is recognized based on the comparison between the detected NFC movement and the predefined NFC movements.

Upon detecting an NFC movement and determining a series of timestamps indicating NFC detection state transitions representing the detected NFC movement, smart device 200 may access smart device memory 206, e.g. in the form of core hardware 208 accessing smart device memory 206. NFC device 200 may obtain timing information associated with one or more predefined NFC movements stored in smart device memory 206. For example, the timing information may include a series of timestamps or durations of time periods (such as e.g. in the form of timestamps) corresponding to NFC_Detection_Active and NFC_Detection_Inactive state. Smart device 200 may then compare the timing information associated with the detected NFC movement to the timing information stored in smart device memory 206 associated with the one or more predefined NFC movements. Smart device memory 206 may additionally contain information associating each of the predefined NFC movements with one or more smart device operations. Smart device 200 may then identify a predefined NFC movement that matches with the detected NFC movement based on the comparison of timing information, and then may perform a smart device action associated with predefined NFC movement.

If the NFC movement is not recognized in 406, smart device 200 may ignore the current detected movement and return to NFC_Detection_Inactive, i.e. to 302 in method 300. Alternatively, if the NFC movement is recognized, smart device 200 may trigger a respective smart device operation. For example, a user may have pre-programmed a smart device operation, such as “return to home screen”, “back/previous screen”, etc., to match a particular NFC movement. Upon recognizing the particular NFC movement in 408, smart device 200 may trigger the associated smart device operation.

Core hardware 208 may be configured to trigger the associated smart device operation of smart device 200. Upon recognizing an NFC movement and identifying a corresponding smart device operation, core hardware 208 may then perform the proper smart device operation, such as by interacting with one or more further components of smart device 200 dependent on the requirements of the corresponding smart device operation. For example, a user may produce an NFC movement matched with a “return to home screen” operation of smart device 200. Core hardware 208 may then perform a “return to home screen operation”, i.e. by changing a display screen of smart device 200 to a home screen, thereby interacting the display screen in order to complete the operation associated with the detected NFC movement. Alternatively, a user may produce an NFC movement matched with a camera operation, such as “take picture”. Core hardware 208 may then perform a “take picture” operation, such as by interacting with a camera of smart device 200 to take a picture.

A variety of different NFC movements may be possible, and may each be defined by a series of timestamps representing times when a proximate NFC accessory entered into NFC field range or exited NFC field range. The series of timestamps indicating NFC_Detection_Active and NFC_Detection_Inactive state, respectively, may be represented as a digital waveform representing an NFC movement. For example, NFC_Detection_Active may represent a high level digital signal in the digital waveform, while NFC_Detection_Inactive may represent a low level digital signal in the digital waveform. Each NFC movement may thus be visually represented with a separate digital waveform composed of high level (NFC_Detection_Active, i.e. NFC accessory within NFC field range) and low level (NFC_Detection_Inactive, i.e. NFC accessory outside of NFC field range) time periods. Each NFC accessory may be associated with any number of separate waveforms, and consequently a number of different operations (e.g. each corresponding to distinct a waveform/movement) may be triggered by each NFC accessory. As the NFC controller 204 may be capable of detecting a UID for each NFC accessory, NFC movements may be re-used between different NFC accessories, and may be configured to trigger the same or different smart device operations. It is appreciated that such variation may be configured or programmed according to user preference or may be implemented by a manufacturer.

As previously detailed, such movements defined by multiple timestamps may be inherently associated with durations, e.g. durations of time representing the time between time stamps. Additionally, it is appreciated that even a single time stamp may entail a duration, as a duration may be determined based on the time following the timestamp, thereby representing the time spent in NFC_Detection_Active or NFC_Detection_Active state following a transition into the state. It is thus understood that related time waveforms are recognized herein as inherently being characterized by at least one duration.

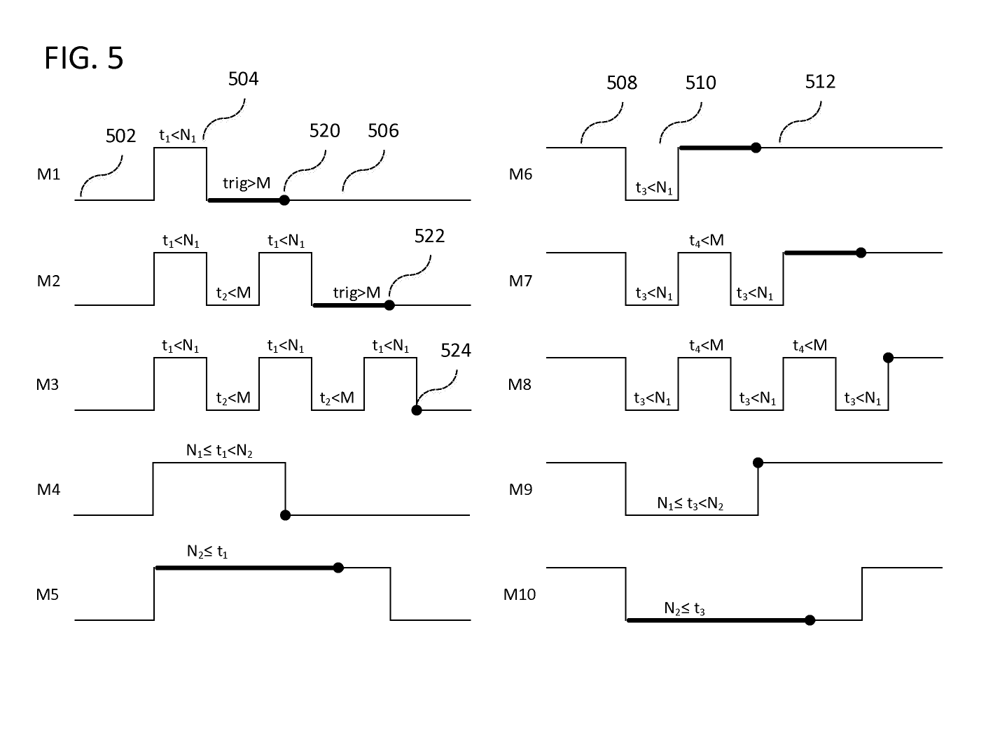

FIG. 5 illustrates a set of different possible NFC movements M1-M10 represented by respective digital waveforms according to an aspect of the disclosure. It is appreciated that each of the detailed NFC movements may be assigned by a user or manufacturer to a different smart device operation, and accordingly may be able to trigger the associated smart device operation upon detection by an NFC-enabled smart device. NFC movements M1-M10 are exemplary in nature, and it is appreciated that a number of variations or alternate movements are possible.

A user may equip NFC accessory 100 on one of their fingers, e.g. a forefinger, and may naturally position their fingers along the back side of a smart device, thereby positioning NFC accessory 100 near the back side of a smartphone. As previously detailed, NFC antennas are conventionally located on the back side of a smart device, and NFC accessory 100 may thus be positioned proximate to the NFC field range.

A user may then slide their finger along the back side of a smart device in order to move NFC accessory 100 within NFC field range (NFC_Detection_Active state) and out of NFC field range (NFC_Detection_Inactive state). The smart device may record then record a timestamp indicating the time in which NFC_Detection_Active/NFC_Detection_Inactive state was entered/exited, and may create a digital waveform with high level and low level signals corresponding to periods of NFC_Detection_Active state and NFC_Detection_Inactive state, respectively. The smart device may then utilize the resulting digital waveform as an NFC movement, and may attempt to match the resulting digital waveform with one or more pre-defined NFC movements (represented by unique digital waveforms) each associated with a pre-registered smart device operation. Alternative to sliding their finger along the back side of a smart device, a user may bend or straighten their finger equipped with NFC accessory 100 in order to alternatively bring NFC accessory 100 further from and closer to the NFC antenna, thereby entering and exiting NFC field range.

NFC controller 204 may thus be configured to provide core hardware 208 with NFC detection information associated with an NFC accessory, such as an indication from a hardware level as to whether an NFC accessory is detected or not. Core hardware 208 may then be configured to determine a corresponding movement waveform based on the NFC detection information, such as in the form of timestamps or durations, thereby allowing smart device 200 to determine a detected NFC movement, e.g. in the form of a waveform.

Smart device 200 may then be configured to compare the detected NFC movement with a database of NFC movements (e.g. as performed on a software layer by core hardware 208), such as stored in smart device memory 206. Smart device 200 may be configured to perform this comparison based on timing information, such as timestamps and durations of time between timestamps. If the detected NFC movement matches with an NFC movement stored in the database, and if the NFC movement stored in the database has been previously assigned a smart device operation, smart device 200 may trigger the assigned smart device operation. For example, core hardware 208 perform the assigned smart device operation by interacting with any necessary further components of smart device 200 as required by the corresponding smart device operation.

NFC movement M1 is illustrated as such a digital waveform consisting of high level and low level signals corresponding to NFC_Detection_Active and NFC_Detection_Inactive state. NFC movement M1 is depicted as a “Quick Pulse” (QP), where an NFC accessory such as NFC accessory 100 enters into NFC field range (NFC_Detection_Active state) and then quickly moves out of NFC field range (NFC_Detection_Inactive state).

A user wearing NFC accessory 100 may thus perform NFC movement M1 by initially holding their finger equipped with NFC accessory 100 in an inactive state, i.e. along the backside of the smart device such that NFC accessory 100 does not fall within NFC field range (NFC_Detection_Inactive state). The user may then slide their finger along the back side of the smart device such that NFC accessory 100 falls within the NFC field range (NFC_Detection_Active state) for a short period of time before sliding their finger back outside of the NFC field range, thereby causing NFC accessory 100 to leave the NFC field range. Alternatively, a user wearing NFC accessory 100 may initially hold their finger in a bent position such that NFC accessory 100 is positioned slightly off the back side of the smart device, and is thus outside of NFC field range (NFC_Detection_Active state). The user may then straighten their finger for a short period of time, causing NFC accessory 100 to become positioned closer to the back of the smart device and thus within NFC field range. The user may then quickly re-bend their finger in order to move NFC accessory 100 back out of NFC detection range.

The illustrated waveform for NFC movement M1 is thus depicted as a period 502 in NFC_Detection_Inactive state (i.e. low level signal) followed by a period 504 in NFC_Detection_Active state (i.e. high level signal) and subsequently followed by a period 506 in NFC_Detection_Inactive state (i.e. low level signal). The time duration of period 504 should be less than a custom defined N₁ milliseconds, i.e. t₁<N₁ where t₁ is the duration of period 504.

NFC movement M2 is depicted as a “Double Quick Pulse” (DQP), where an NFC accessory performs two consecutive QP movements (each with a period N₁ in NFC_Detection_Active state) and the interval t₂ between the two consecutive QP movements is less than a custom defined M milliseconds.

In addition to depicting the shape of the digital waveform associated with NFC movements M1 and M2, FIG. 5 additionally depicts triggering points 520 and 522. Triggering points 520 and 522 indicate the point in time in which smart device 200 may complete recognition of NFC movements M1 and M2 and proceed to trigger an associated smart device operation. Smart device 200 may be configured to complete recognition of NFC movements M1 and M2 according to triggering points 520 and 522 in order to differentiate between the QP and DQP movements of NFC movements M1 and M2. For example, if smart device 200 is configured to immediately trigger movement M1 upon detection of an NFC_Detection_Inactive→NFC_Detection_Active→NFC_Detection_Inactive state sequence where the NFC_Detection_Active state is less than N₁ milliseconds, smart device 200 may mistakenly recognize NFC movement M2 as NFC movement M1 (and similarly for the NFC movement M3). Accordingly, smart device 200 may be configured to wait a certain amount of time until triggering points 520 and 522 following completion of a QP in order to determine which NFC movement was completed. As shown regarding NFC movement M2, a DQP movement may be recognized upon detection of an NFC_Detection_Inactive→NFC_Detection_Active→NFC_Detection_Inactive→NFC_Detection_Active→NFC_Detection_Inactive state sequence, where the second NFC_Detection_Inactive period is less than M milliseconds. Accordingly, smart device 200 may be configured to wait at least M milliseconds following detection of a QP movement in order to determine that the most recent QP movement is the final QP movement of the current NFC movement. In this manner, NFC controller 204 may ensure that all desired QP movements are detected (assuming the user has correctly performed the QP movements according to the timing constraints N₁ and M) and avoid prematurely triggering recognition of a QP-based NFC movement before a user has finished performing the full NFC movement.

NFC movement M3 is depicted as a “Triple Quick Pulse” (TQP), where an NFC accessory does three consecutive QP movements and the interval t₂ is less than a custom defined M milliseconds. As shown in FIG. 5, triggering point 524 for NFC movement M3 is temporally located at the exact point in time where the third QP in the triple QP sequence is completed. As the provided set of NFC movements have a maximum of three QPs (for TQP), it may be possible to recognize three quick pulses as NFC movement M3 immediately after the third QP is complete, as there is no defined NFC movement consisting of four QPs that could potentially be mistakenly recognized as NFC movement M3. Accordingly, trigger point 524 may need to be adjusted if NFC movements are utilized that consist of three or more QPs.

NFC movement M4 is depicted as a “Normal Pulse” (NP), where an NFC accessory enters into NFC field range and then moves out of NFC field range and the duration of the NFC_Detection_Active state (i.e. time spent within NFC field range) is greater than the custom defined N₁ value and less than a custom defined N₂ value.

NFC movement M5 is depicted as “Turn Active” (TA), where an NFC accessory enters into NFC field range (NFC_Detection_Active state) and remains in NFC_Detection_Active state for more than N₂ milliseconds.

Smart device 200 may therefore detect NFC movements and determine whether or not the NFC movement is recognized. If the NFC movement is recognized and has been associated with a smart device operation, the respective operation is then triggered, such as by signaling between NFC controller 204 and core hardware 208.

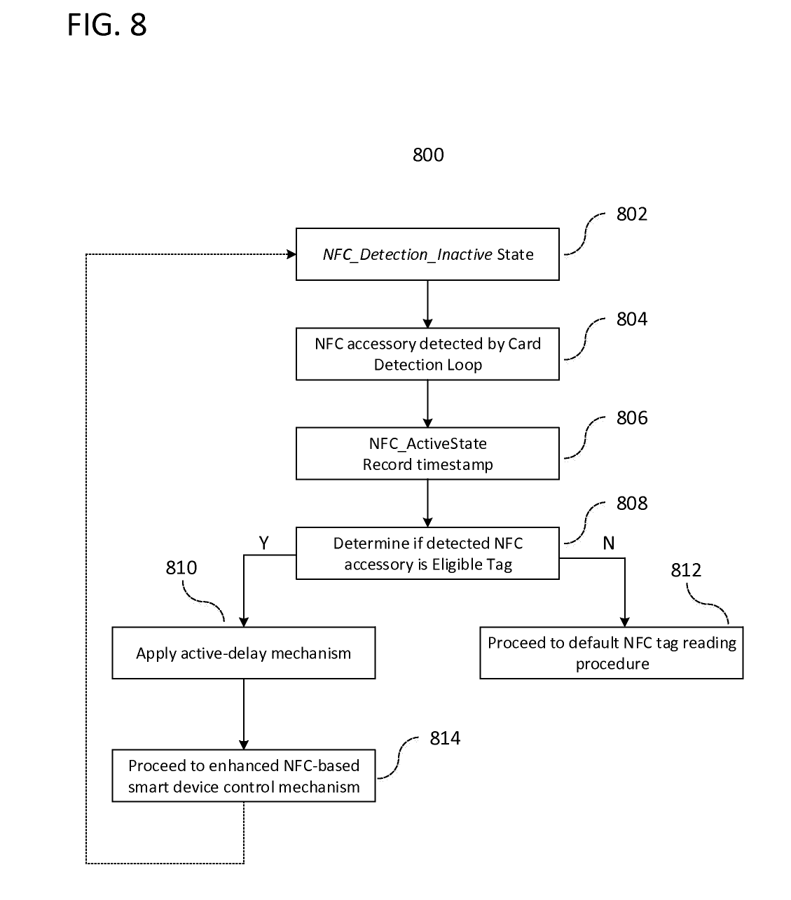

NFC movements M1-M5 may be utilized if the “Idle State” of a user wearing an NFC accessory is NFC_Detection_Inactive. In other words, if a user naturally holds a smart device in their hand and the NFC accessory is not within NFC field range, the Idle State is defined as NFC_Detection_Inactive. In contrast, if a user naturally holds a smart device in their hand and the NFC accessory is within NFC field range, the Idle State is defined as NFC_Detection_Active. Accordingly, a user with Idle State as NFC_Detection_Inactive may naturally position an NFC accessory in NFC_Detection_Inactive state, and may perform one of NFC movements M1-M5 starting from NFC_Detection_Inactive state (i.e. as in period 502). It is appreciated that method 300 as detailed regarding FIG. 3 and method 800 to be detailed regarding FIG. 8 may be similarly adapted to initiate from NFC_Detection_Active state as opposed to NFC_Detection_Inactive to correspond with a potential user having Idle State as NFC_Detection_Active state.

A user with Idle State as NFC_Detection_Active state may therefore wish to perform NFC movements starting from an initial NFC_Detection_Active state. Accordingly, NFC movements M6-M10 represent the exclusive OR (XOR) logical operation of movements M1-M5, and correspondingly may be initiated from an NFC_Detection_Active state as in period 508. The initial NFC_Detection_Active state in period 508 may be followed by e.g. at least one NFC_Detection_Inactive state in period 510 and a further NFC_Detection_Active state in period 512.

NFC movements M6-M10 represent the exclusive OR (XOR) signal of NFC movements M1-M5, and may be utilized dependent on the “Idle” NFC detection state of a user wearing an NFC accessory. It is additionally appreciated that while many of the implementations detailed herein relate to users with and NFC_Detection_Active Idle State, the operations may be inversed (such as done regarding NFC movements M6-M10) to operate according to a user with an NFC_Detection_Inactive Idle State.

Although NFC movements M1-M10 have been depicted as either containing one of QP movements, NP movements, or TA movements, it is appreciated that other different movements may be utilized to define NFC movements, such as e.g. one or more QP movements may be combined with one or more NP movements in addition to at least one TA movement in order to define numerous other NFC movements. The provided NFC movements are exemplary in nature, and not intended to be limiting in any respect to a possible set of NFC movements.

As previously detailed, smart device 200 may be configured to record timestamps indicating when NFC accessory 100 enters NFC field range and exits NFC field range, and may be configured to recognize an associated NFC movement based on the recorded timestamps. Smart device 200 may be configured to calculate one or more durations of time during which smart device 200 is in NFC_Detection_Active state or in NFC_Detection_Inactive state (e.g. on a software level as executed by core hardware 208), such as by comparing the differences between timestamps indicating an entry into NFC_Detection_Active state and subsequent exit therefrom. Smart device 200 may calculate one or more such durations, such as duration t₁ for NFC movement M1 (corresponding to the duration of time in NFC_Detection_Active state for a QP movement), durations t₁ and t₂ for NFC movement M2 (corresponding to the two durations of time in NFC_Detection_Active state for the two QP movements), durations t₁ and t₂ for NFC movement M3, etc.

Smart device 200 may then compare the calculated durations t₁ and/or t₂ to one or more duration thresholds, such as N₁, N₂, and M, and may trigger an associated smart device operation based thereon. For example, in order to detect NFC movement M1, smart device 200 may record timestamps corresponding to state transitions from NFC_Detection_Inactive→NFC_Detection_Active→NFC_Detection_Inactive. Smart device 200 may then compare the duration of time in NFC_Detection_Active state t₁ to N₁ and N₂ to determine whether t₁<N₁, N₁<t₁<N₂, or t₁>N₂. If t₁<N₁, smart device 200 may determine that a QP movement has been performed, which may correspond to any of NFC movement M1-M3 has been performed as shown in FIG. 5. As will be later detailed, smart device 200 may be configured to distinguish between NFC movements M1-M3 using triggering points. In the current exemplary scenario, smart device 200 may determine that NFC movement M1 has been performed, such as through the use of triggering points, and may subsequently trigger a predefined operation corresponding to NFC movement M1 (such as pre-programmed by a user). Alternatively, smart device 200 may determine that N₁<t₁<N₂, and thus an NP movement corresponding to NFC movement M4 has been performed. Smart device 200 may alternatively determine that t₁>N₂, in which case a TA movement corresponding to M5 has been performed. Smart device 200 may therefore utilized recorded timestamps in order to determine the appropriate duration in a particular state, such as the duration of t₁ in which smart device 200 is in NFC_Detection_Active state in the aforementioned examples, and compare the determined duration to one or more thresholds or other timing measures in order to identify which NFC movement has been performed.

Smart device 200 may also be configured to compare durations of time in order to implement triggering points, such as triggering points 520 and 522 as shown in FIG. 5. As previously indicated, smart device 200 may employ triggering points in order to distinguish between certain NFC movements, such as the NFC movements M1-M3 as shown in FIG. 5. For example, smart device 200 may be configured to calculate the duration of time that has passed since the last state change. In reference to NFC movement M1, after identifying the duration of period 504 t₁ as consistent with a QP movement, smart device 200 may determine how much time has passed in period 506 since the transition from NFC_Detection_Active state to NFC_Detection_Inactive state. If the duration of time exceeds M, smart device 200 may recognize that the performed movement qualifies as NFC movement M1 (as the user did not perform a second QP within M milliseconds), and proceed to trigger any corresponding smart device operation. Smart device 200 may be required to operate similarly to recognize e.g. NFC movement M2, as smart device 200 may need to determine that the second QP movement was performed within M milliseconds of the first QP movement. Accordingly, the NFC movement being performed should be interpreted as an NFC movement M2 or M3 instead of a series of separate NFC movements M1.

Smart device 200 may utilize a waveform database containing timing information regarding each stored movement to compare a performed movement (i.e. an NFC movement performed by a user with an NFC accessory) to one or more predefined movements. Smart device 200 may determine corresponding timing information corresponding to a performed movement, and compare the timing information corresponding to a performed movement to timing information stored in the database. For example, smart device 200 may compare timing information corresponding to a performed movement to timing information for each movement stored in the database in order to determine if the timing information corresponding to the performed movement matches timing information for any of the movements stored in the database. Timing information may be based on timestamps, where the timestamps indicate a transition between NFC_Detection_Active and NFC_Detection_Inactive state, and may be in the form of timestamps and/or duration information indicating time periods between successive timestamps.

Such duration-based comparisons may be based on the timestamps recording indicating state transitions between NFC_Detection_Active and NFC_Detection_Inactive state. Smart device 200 may thus calculate durations from the recorded timestamps, and utilize the calculated durations in order to recognize different NFC movements.

FIG. 6 illustrates scenarios 600-606. Scenarios 600-606 depict examples of NFC accessory positioning in relation to NFC detection state and the position of NFC field range of smart device 200. In scenario 600 and 602, a user is depicted as wearing NFC accessory 100 on their forefinger. The user may position NFC accessory 100 on the back of smart device 200, and may perform the requisite movements to trigger NFC_Detection_Active and NFC_Detection_Inactive state by moving their finger along the backside of smart device 200 into and out of the NFC field range. The user may naturally hold their finger equipped with NFC accessory 100 in location 610. As shown in scenario 600, the NFC field range (shaded area) of smart device 200 is positioned in the top region of the profile of smart device 200. Accordingly, the user's Idle State is NFC_Detection_Inactive. The user may trigger smart device operations according to the enhanced NFC-based smart device control protocols by moving NFC accessory 100 into the NFC field range in scenario 600. For example, the user may slide their forefinger equipped with NFC accessory 100 to location 612, which is located within the NFC field range. The user may then create different waveforms by moving their forefinger into the NFC field range and out of the NFC field range, thereby creating a waveform of high and low level signals representing NFC_Detection_Active and NFC_Detection_Inactive states. By performing preconfigured NFC movements, such as movements M1-M5 (as the user's Idle State is NFC_Detection_Inactive), a user may trigger a variety of different smart device operations using NFC accessory 100.

In scenario 602, the NFC field range of smart device 200 may be located in the bottom region of the profile of smart device 200. It is appreciated that the NFC field range of a smart device may be dependent on factors such as the position of the NFC antenna and additional profile characteristics of the smart device. Conventionally, NFC antennas are built close to the back of a smart device, and the NFC field range is typically limited to an area at the back of a smartphone. Additionally, the user may rotate their finger so NFC inlay 120 is pointing towards or sideways to the NFC filed of smart device 200 as detailed regarding FIG. 1 in order to adjust the detection sensitivity of NFC accessory 100 by smart device 200.

As depicted in scenario 602, the user may naturally hold their forefinger equipped with NFC accessory 100 near the back of smart device 200 in location 612. Accordingly, the user's natural positioning of NFC accessory 100 may fall outside the NFC field range of smart device 200. The user's Idle State is therefore NFC_Detection_Inactive state, and the user may thus utilize movements M1-M5 to trigger smart device operations by moving their finger into NFC field range (NFC_Detection_Inactive) and out of NFC field range, such as to location 610 (NFC_Detection_Active).

Scenario 604 illustrates an alternative example in which a user naturally bends their finger equipped with NFC accessory 100, which is located at location 614. As the user's bent finger equipped with NFC accessory 100 is slightly displaced from the back of smart device 200, NFC accessory 100 may fall outside of the NFC field range. Accordingly, the user's Idle State may be NFC_Detection_Inactive. The user may thus perform NFC movements by straightening and re-bending their finger, thereby moving NFC accessory 100 closer to and further from the back of smart device 200 and correspondingly triggering NFC_Detection_Active and NFC_Detection_Inactive state. For example, the user may straighten their finger equipped with NFC accessory 100 to move NFC accessory 100 into location 616, which may be proximate to the back of smart device 200 and consequently within NFC field range.

Alternatively, a user may naturally position their finger equipped with NFC accessory 100 in a straightened (i.e. un-bent) position as shown in scenario 606. Accordingly, the user may naturally position NFC accessory 100 in location 616, which is located within the NFC field range of smart device 200. The user's Idle State may thus be NFC_Detection_Active state. The user may then bend and straighten (i.e. un-bend) their finger equipped with NFC accessory 100 in order to move NFC accessory 100 into the NFC field range and out of the NFC field range in order to perform one of e.g. NFC movements M6-M10 (as the user's Idle State is NFC_Detection_Active).

Alternatively, a manufacturer or user may be able to configure (e.g. via an Application Program Interface) the NFC field strength or other NFC related parameters to adjust the detection sensitivity of NFC accessory 100 by smart device 200.

It is appreciated that implementations related to this disclosure are not limited to the movements and scenarios as detailed herein, and it is thus understood that the implementations detailed herein are exemplary in nature. It is appreciated that the NFC movements M1-M10, in particular NFC movements M1-M4 and M6-M9 may be completed by a user in relatively short duration, e.g. several hundreds of milliseconds, before triggering a smartphone operation. Accordingly, users may not experience noticeable latency when triggering smart phone operations with the proposed NFC movements. The enhanced NFC-based smart device control mechanisms provided herein may be executed quickly compared to traditional button presses, and may additionally provide further simplicity due to the eliminated requirement to physically reach each smart device button.

The movement criteria associated with each NFC movement, such as recorded timestamps and the resulting timing durations N₁, N₂, and M, may be configured based on a user's preference. In addition, further waveforms represented by alternating high level (NFC_Detection_Active) and low level (NFC_Detection_Inactive) may be defined by a user, thereby allowing a user to the option to freely define the mappings of finger movements and associate any desired smart device operations therewith. The NFC movements may be defined according to a user's preference. The NFC movements may also be based on “fuzzy logic”, which does not require a user to exactly match a performed finger movement to a registered NFC movement in order to trigger an associated smart device operation. Smart device 200 may be configured to recognize the defined movements using fuzzy logic, and the user may thus not be required to move the finger to identically match a particular movement or stay in place (i.e. within NFC field range or out of NFC field range) for exactly a certain amount of time to trigger an operation. A user may therefore be provided with a greater ease of use and improved user experience.

Furthermore, an NFC Detection State Indicator may be implemented on a smart device, such as on a status bar on a virtual display or as a physical light indicator. The NFC Detection State Indicator may then be used to visually indicate the current NFC detection state (NFC_Detection_Active or NFC_Detection_Inactive) based on the current positioning of an eligible NFC accessory. Such an instantaneous display of NFC detection state may assist in keeping a user aware of the varying NFC detection states in real time, and may assist in allowing a user to perform more accurate movements to trigger expected operations.

Additionally, a user or manufacturer may be able to custom-define different movements, which may accordingly not be limited to the provided NFC movements M1-M10. A user may therefore be provided with a smart device application to record specific movements, such as by recording a waveform representing varying NFC detection states. The recorded NFC movement may then be defined and stored according to the associated timing information, such as timestamps indicating NFC detection state transitions between NFC_Detection_Active and NFC_Detection_Inactive. After recording and approving an NFC movement, a user may be able to assign a specific smart device operation to the movement, thereby allowing the user an increased level of customization.

Each of the defined NFC movements may be utilized to trigger different actions depending on the current status of smart device 200. For example, a specific movement may be assigned to trigger a “back/previous screen” if smart device 200 is virtually displaying a first virtual menu or at system level, and may be also assigned to trigger “start/stop playback” if smart device 200 is providing multimedia, such as in a steam play application. Other similar options include taking a picture when a camera application is on and locking the screen when smart device 200 is at the home screen. Such configuration options may be made available to a user for increased customization.

In the exemplary aspects of the disclosure detailed above, smart device operations are triggered based on NFC movements defined by NFC detection state waveforms. NFC movements must therefore be identified by a smart device (such as by smart device 200 via a software layer) before a smart device operation is triggered. In an alternative implementation, operations of a smart device may be triggered immediately based on the current NFC detection state, and consequently no movements need to be recognized before triggering an operation.

For example, a user may be performing text editing using a soft keyboard (i.e. virtual) on smart device 200, such as in a text message. Smart device 200 may detect NFC accessory 100 within NFC field range (NFC_Detection_Active state), and may shift to capital letter entry for text editing. Smart device 200 may then shift back to lowercase letter entry if smart device 200 enters back into NFC_Detection_Inactive state.

In another example, smart device 200 may trigger a “scroll down” operation when NFC_Detection_Active state is triggered and smart device 200 is in a page-view interface, such as e.g. displaying a webpage. Alternatively, smart device 200 may stop scrolling upon triggering of NFC_Detection_Inactive state.

In a further example, NFC accessory 100 may be used to copy and paste data between two separate smart devices. In contrast to the default “copy/paste” operation, which is only available in one smart device through “clipboard” functionality, the proposed enhanced NFC-based copy/paste operation may enable interoperation between two NFC-enabled smart devices. For example, if an NFC accessory such as NFC accessory 100 is detected (i.e. NFC_Detection_Active state) and a “copy” command (i.e. via an edit menu or “Ctrl+C”) is triggered, the selected text may be written into NFC accessory 100, such as e.g. by NFC signaling through NFC antenna 202 controlled by NFC controller 204. The selected text may be written as an NDEF message in NFC accessory 100 instead of being simply copied onto the local clipboard of smart device 200. If NFC accessory 100 is then detected by another NFC-enabled smart device and a “paste” command is triggered, the text previously copied onto NFC accessory 100 may be read from NFC accessory 100 (such as from the NDEF message of NFC accessory 100) by the other NFC-enabled smart device and pasted into the selected area.

The operations detailed above may thus be classified as “operation modes”, and may be predefined, such as e.g. by a user or manufacturer. Smart device 200 may thus be configured to switch between operation modes, such as a first operation mode and a second operation mode, based on the detection state of smart device 200. For example, a user may be able to configure smart device 200 to operate with uppercase text entry as a first operation mode and with lowercase text entry as a second operation mode. The user may then configured the first operation mode to be associated with NFC_Detection_Active state and the second operation mode to be associated with NFC_Detection_Inactive state, where the user's Idle State is NFC_Detection_Inactive.

Smart device 200 may then switch between uppercase and lower text entry corresponding to the first operation mode and the second operation mode depending on the current detection state of smart device 200. It is appreciated that the above example is exemplary in nature, and may be configurable in various additional manners, such as depending on desired operation modes and/or the user's Idle State.

Furthermore, smart device 200 may be configured to operate according to such operation modes based on context information, such as the action a user is currently performing on smart device 200. For example, smart device 200 may be configured to have uppercase text entry as a first operation mode, lowercase text entry as a second operation mode, scroll down as a third operation mode, and no scroll as a fourth operation mode.

If a user is operating a text-entry application, such as a text messaging or other word-processing application, smart device 200 may be configured to operate in either the first operation mode or the second operation mode (e.g. corresponding to text entry) depending on the detection state of smart device 200. If the user is not operating a text entry application and is e.g. utilizing an application that supports scrolling such as a web page browser or mobile reader, smart device 200 may be configured to operate in either the third operation mode or fourth operation mode (i.e. scroll-down or no scroll) depending on the detection state of smart device 200. It is appreciated that many further variations are possible and embraced herein by this disclosure.

As detailed regarding FIG. 3, an important feature of the proposed enhanced NFC-based smart device control is that there is no impact on current standard NFC functionality and operations. When a smart device such as smart device 200 implementing enhanced NFC-based smart device control first detects an NFC accessory, smart device 200 initially reads information specific to the NFC accessory. The information may include a UID, block data, NDEF message, etc., and may be stored in a memory or storage device as part of an NFC inlay. Smart device 200 may be configured to decide which information should be read to perform proper identification of the NFC accessory, and may complete the reading operation in several milliseconds. Based on the read information, smart device 200 may then render a decision as to whether the NFC accessory is an Eligible Tag (i.e. the NFC accessory been pre-registered to interact with smart device 200 according to enhanced NFC-based smart device control protocols) or is alternatively a “normal” tag (i.e. the NFC accessory has not been pre-configured and should be interacted with according to default NFC procedures).

Smart device 200 may be provided with an Eligible Tag Information Table (RTIT) that contains information regarding Eligible Tags (i.e. eligible NFC accessories), such as UIDs, block data, and NDEF messages associated with Eligible Tags. The RTIT may be open to customization to a user, and accordingly may allow a user to add or remove identification information associated with specific NFC accessories in order to configured desired NFC accessories for use with enhanced NFC-based smart device control.

Smart device 200 may customize which information provided by a detected NFC accessory to read. Once smart device 200 detects an NFC accessory, smart device 200 may read the appropriate identification information and perform a comparison with the information in the RTIT to determine whether the NFC accessory is an Eligible Tag (i.e. as done in 308 of method 300). If the information read from the NFC accessory matches information in the RTIT, the NFC accessory is considered as an Eligible Tag and may accordingly be used as a controller for enhanced NFC-based smart device control, such as detailed regarding method 400 of FIG. 4. The NFC accessory may be either used for movement recognition-based control (recognition of predefined NFC movements) or state-based control (immediate triggering of a predefined operation based on NFC detection state). Accordingly, the default NFC tag reading procedure may be ignored.

Alternatively, if the information read from the NFC accessory does not match any identification information in the RTIT, smart device 200 may treat the NFC accessory as a normal NFC tag (i.e. not an Eligible Tag). Smart device 200 may then proceed with default NFC operations.

The implementation of the identification scenarios may be deployed at an upper software layer, such as the Framework layer in an Android Operating System, and may be physically executed by e.g. a processor. The implementation of the identification scenarios at an upper layer may avoid any impact on the current NFC tag reading procedures.

A user may add the UID unique to an NFC accessory to the RTIT in order to register the NFC accessory as an Eligible Tag. Additionally, a user may also custom-define a specific type of data stored in an NFC accessory (e.g. eligible NFC block data, eligible NDEF message, etc.) and update the data to both the RUT and the normal tag.

Smart device 200 may additionally be provided with an active-delay based mechanism to enhance the robustness of the ability of smart device 200 to correctly recognize NFC movements. In reference to FIG. 4, smart device 200 may implement an NFC Tag Presence Loop via NFC controller 204, which may perform a check every X milliseconds as to whether an NFC accessory such as NFC accessory 100 remains within NFC field range. The NFC Tag Presence Loop may thus be utilized in order to detect when a previously detected NFC accessory exits the NFC field range. Smart device 200 may record a series of timestamps signifying NFC_Detection_Active and NFC_Detection_Inactive state based on whether the NFC Tag Presence Loop determines that the NFC accessory has entered or exited the NFC field range.

However, the NFC Tag Presence loop may be prone to false results, such as where the NFC Tag Presence Loop mistakenly signals a “Tag Not Present” (i.e. indicating that the NFC accessory is no longer within NFC field range) when the NFC accessory has remained in the NFC field range. Smart device 200 may therefore incorrectly record a timestamp signaling NFC_Detection_Inactive state, which may prevent a desired user NFC movement from being properly recognized due to the incorrect timestamp. A potential cause for a mistaken “Tag Not Present” result is extremely rapid movement of the NFC accessory within the NFC field range. Such rapid movement may mistakenly cause NFC controller 204 to fail to determine that the NFC accessory remains within NFC field range. However, the NFC accessory may be rapidly re-detected by the Card Detection Loop (304 in method 300) implemented in Firmware level. Smart device 200 may record the associated timestamps (recorded at the “Tag Not Present” result time of NFC Tag Presence Loop and at the re-detection by Card Detection Loop) as a series of NFC_Detection_Active and NFC_Detection_Active states similar to a QP movement. However, the user has in actuality not performed any such QP movement, and NFC controller 204 may then mistakenly recognize or fail to recognize an NFC movement performed by the user.

In order to prevent such mistaken “Tag Not Present” results from NFC Tag Presence Loop, smart device 200 may implement an active-delay mechanism. Once smart device 200 enters NFC_Detection_Active state (following initial detection of an NFC accessory), if the NFC accessory is detected or re-detected either by the Card Detection Loop (e.g. at firmware level) or if the NFC Tag Presence Loop returns a “Tag Present” result (e.g. at software level) at a time timestampᵢ, smart device 200 may forcibly extend NFC_Detection_Active state for a period of time t following timestampᵢ. The parameter t may be customized in a custom manner, such set to any value t=k*X, where X is the loop duration of the NFC Presence Tag Loop and k=2, 3, etc. This process may recursively repeat, causing smart device 200 to remain in NFC_Detection_Active state for a period of time t following the most recent detection by the Card Detection Loop or “Tag Present” result from the NFC Presence Tag Loop, even if the NFC Presence Tag Loop returns a “Tag Not Present” result during the period of time t. However, if all of the NFC Presence Tag Loop results during the period of time t are “Tag Not Present” and the NFC accessory is not re-detected by the Card Detection Loop, NFC controller 204 may then consider that the NFC accessory has exited the NFC field range. NFC controller 204 may then enter NFC_Detection_Inactive state.

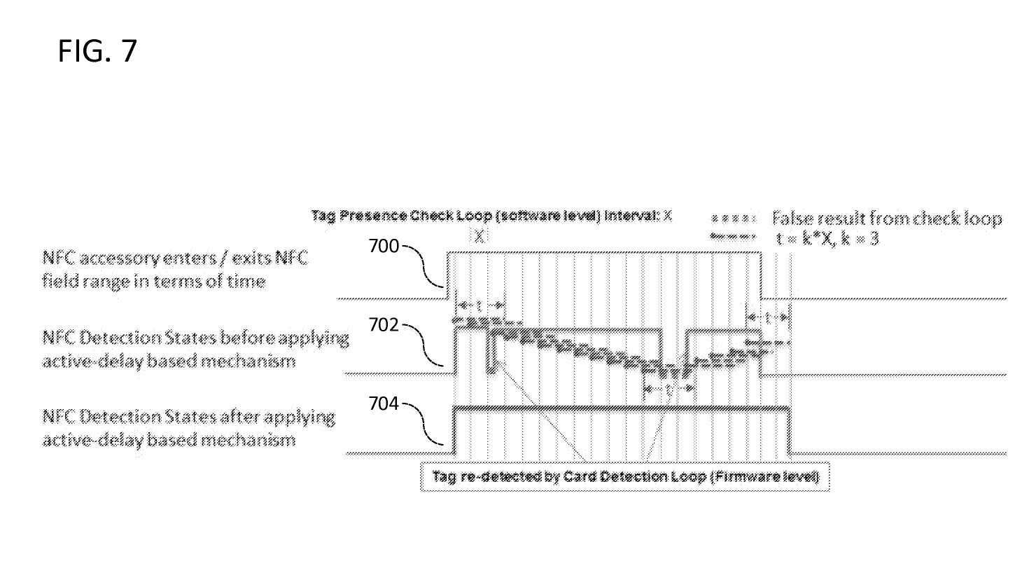

FIG. 7 illustrates a scenario in which smart device 200 may implement the active-delay mechanism with parameter k=3. Waveform 700 depicts whether the NFC accessory is physically within NFC field range (high level signal) or is physically outside of NFC field range (low level signal). Waveform 702 depicts the NFC detection state of smart device 200 before applying the active delay mechanism. As shown in waveform 702, NFC Tag Presence Loop may mistakenly return incorrect “Tag Not Present” results, which are shown at t=2 and t=12. However, the Card Detection Loop may quickly re-detect the presence of the NFC accessory, as the NFC accessory has not physically exited the NFC field range (as indicated by waveform 700). Accordingly, waveform 704 depicts the NFC detection state of smart device 200 after applying active-delay mechanisms. As the presence of the NFC accessory is quickly re-detected by the Card Detection Loop within t=3X milliseconds, smart device 200 remains in NFC_Detection_Active state and does not immediately fall back to NFC_Detection_Inactive state upon return of a “Tag Not Present” result by the NFC Tag Presence Loop.

In other words, smart device 200 will remain in NFC_Detection_Active state unless the NFC Tag Presence Loop indicates that the NFC accessory is not within NFC field range for a period of t=3X milliseconds following detection of the NFC accessory by either loop. Accordingly, smart device 200 delays NFC_Detection_Active state for a period of time (k−1)*X milliseconds before falling to NFC_Detection_Inactive state. Incorrect premature triggering of NFC_Detection_Inactive state may thus be avoided through the implementation of the active-delay mechanism. In the event that the NFC accessory is determined to have exited the NFC field range, the timestamp associated with the initial “Tag Not Present” result may be utilized by smart device 200 to define the recorded NFC movement. The custom-defined movement criteria related to NFC movements M1-M10, such as N₁, N₂, etc., may be also adjusted accordingly. It is appreciated that the active-delay mechanism may also be applied to the non-movement based operation triggering, such as toggling uppercase text entry or scrolling up/down a displayed page.

FIG. 8 illustrates an exemplary method 800 for enabling smart device 200 to detect an NFC accessory such as NFC accessory 100 using the active-delay mechanism. In 802, method 800 may begin in NFC_Detection_Inactive state, where no NFC accessory is detected within the NFC field range. Smart device 200 may be in an “NFC polling mode” and have an NFC Card Detection Loop enabled. In 804, NFC controller 204 may detect an NFC accessory, such as on a firmware level by the NFC Card Detection Loop. Smart device 200 may subsequently enter NFC_Detection_Active state, such as on a software level within core hardware 208, and may record a timestamp indicating the initiation of NFC_Detection_Active state in 806. NFC controller may then determine if the detected NFC accessory is an Eligible Tag in 808, such as by performing a read operation of information stored on the NFC accessory and comparing the read information to a database containing identification information for Eligible Tags. If the NFC accessory is not an Eligible Tag, method 800 may proceed to 812 to perform default NFC accessory procedures. If the NFC accessory is an Eligible Tag, method 800 may apply an active-delay mechanism in 810. As smart device 200 entered into NFC_Detection_Active state in 806, the active-delay mechanism may involve extending NFC_Detection_Active state until the NFC Tag Presence Loop signal that the NFC accessory is not within NFC field range for at least a pre-defined duration (e.g. t=k*X milliseconds). Method 800 may then utilize the active delay mechanism to proceed to enhanced NFC-based smart device control in 814 in order to detect user NFC movements, thereby enabling smart device control. As further depicted in FIG. 8, method 800 may be implemented in a repetitive manner, and may return to NFC_Detection_Inactive state in 802 after executing the enhanced NFC-based smart device control mechanism in 814.

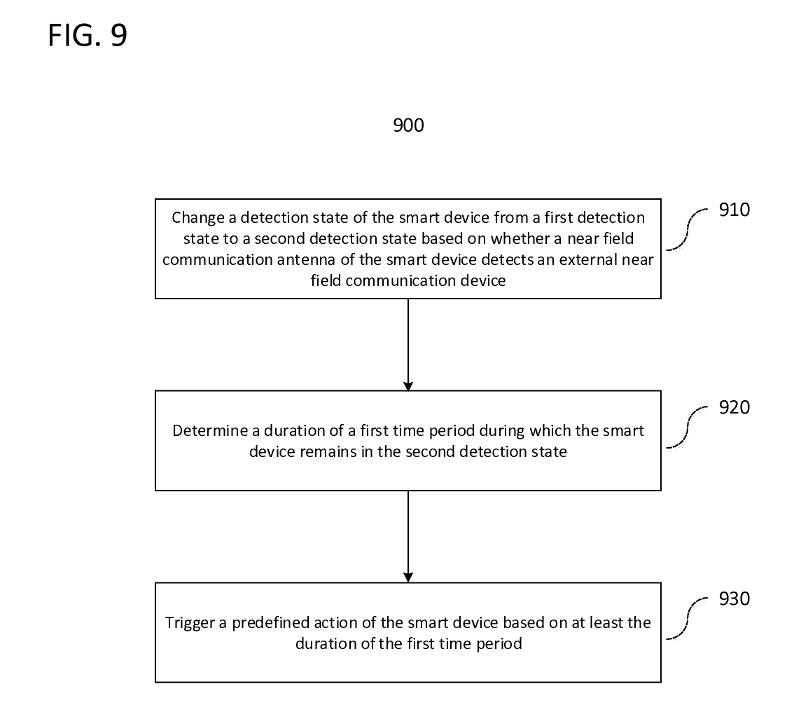

FIG. 9 shows a flow diagram illustrating method 900 for controlling a smart device. Method 900 may change a detection state of the smart device from a first detection state to a second detection state based on whether a near field communication antenna of the smart device detects an external near field communication device in 910. In 920, method 900 may determine a duration of a first time period during which the smart device remains in the second detection state. Method 900 may then trigger a predefined action of the smart device based on at least the duration of the first time period in 930.

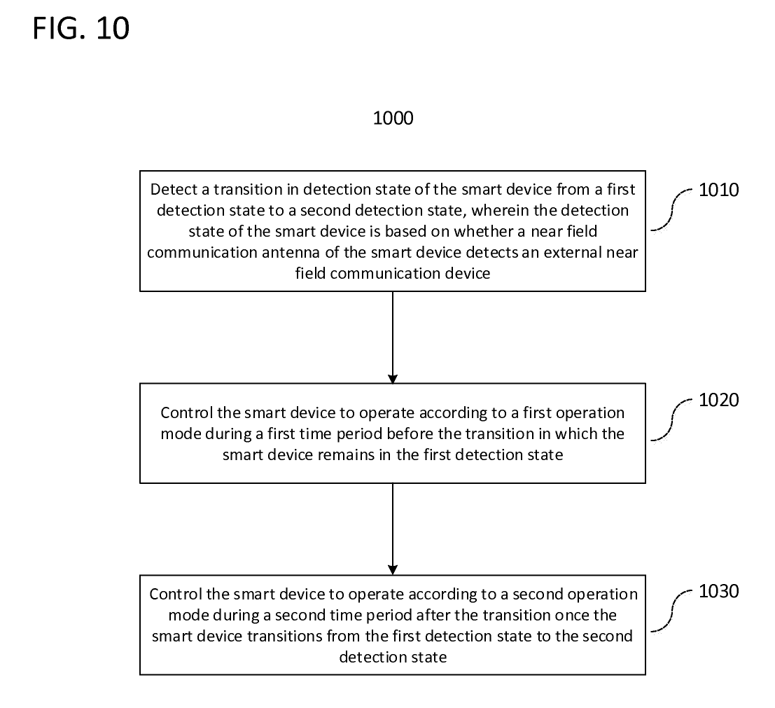

FIG. 10 shows a flow diagram illustrating method 1000 for controlling a smart device. In 1010, method 1000 may detect a transition in detection state of the smart device from a first detection state to a second detection state, wherein the detection state of the smart device is based on whether a near field communication antenna of the smart device detects an external near field communication device. Method 1000 may then control the smart device to operate according to a first operation mode during a first time period before the transition in which the smart device remains in the first detection state in 1020. Method 1000 may control the smart device to operate according to a second operation mode during a second time period after the transition once the smart device transitions from the first detection state to the second detection state in 1030.

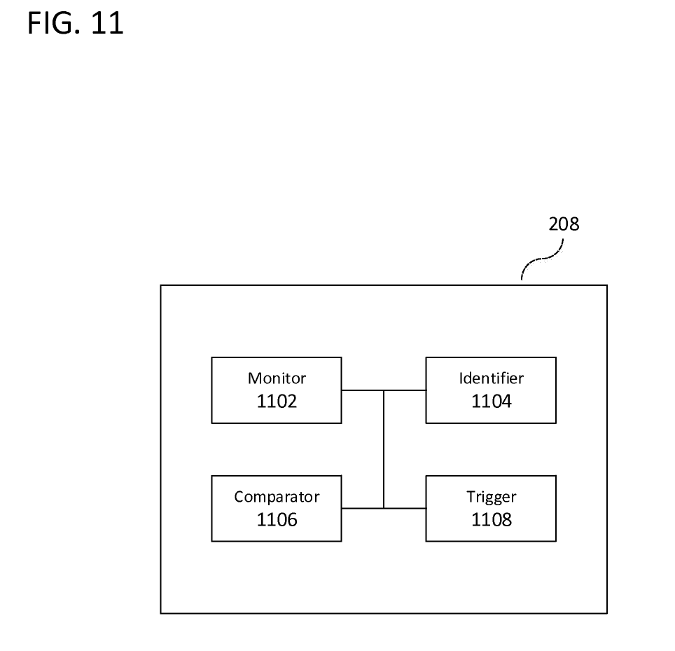

FIG. 11 shows a block diagram illustrating exemplary internal components of core hardware 208 of FIG. 2.

As shown in FIG. 11, core hardware 208 may include monitor 1102, identifier 1104, comparator 1106, and trigger 1108. Monitor 1102, identifier 1104, comparator 1106, and trigger 1108 may each be configured to implement features of the smart device control process detailed above, in particular the enhanced NFC-based smart device control detailed regarding FIGS. 3-8.

In an exemplary aspect of the disclosure, core hardware 208 may be provided as an internal component of a smart device, such as detailed regarding smart device 200 in FIG. 2. In this exemplary aspect of the disclosure, smart device 200 may include an antenna such as antenna 202 configured to detect an external near field communication device. Monitor 1102 may be configured to monitor a series of one or more transitions in a detection state of smart device 200 between a first detection state and a second detection state based on whether the near field communication antenna detects the near field communication device.

Comparator 1104 may be configured to perform a comparison between first timing information associated with the series of one or more transitions and second timing information associated with a first predefined series of one or more transitions.

Trigger 1106 may be configured to initiate a predefined action of smart device 200 based on the comparison.

Identifier 1108 may be configured to determine identification information of the external near field communication device.

Accordingly, monitor 1102, identifier 1104, comparator 1106, and trigger 1108 may be configured to perform one or more features of core hardware 208. It is appreciated that one or more of the features and/or functionality of monitor 1102, identifier 1104, comparator 1106, and trigger 1108 may e.g. be combined into a single component, or may e.g. all be integrated to form a single component, such as core hardware 208.

Monitor 1102, identifier 1104, comparator 1106, and trigger 1108 may be implemented as hardware, software, or a combination of hardware and software. In an exemplary aspect of the present disclosure, monitor 1102, identifier 1104, comparator 1106, and trigger 1108 may each be implemented as one or more software modules by processing circuitry of core hardware 208, such as software processes executed by an application processor (i.e. core hardware 208) of smart device 200. In another exemplary aspect of the present disclosure, monitor 1102, identifier 1104, comparator 1106, and trigger 1108 may each be implemented as one or more dedicated hardware components of core hardware 208. It is appreciated that many such variations are considered within the scope of this disclosure and accordingly are understood to be embraced herein.

It is appreciated that core hardware 208 may further or alternatively include one or more additional elements. In an exemplary aspect of the disclosure, core hardware 208 may include e.g. a detector configured to change a transition in detection state of the device from a first detection state to a second detection state, wherein the detection state of the device is based on whether the near field communication antenna detects the external near field communication device or e.g. a controller configured to control the device to operate according a first operation mode during a first time period before the transition in which the device remains in the first detection state and control the device to operate according to a second operation mode during a second time period after the transition once the device transitions from the first detection state to the second detection state. In a further exemplary aspect of the disclosure, core hardware 208 may include e.g. a monitor configured to monitor a series of one or more transitions in a detection state of the device between a first detection state and a second detection state based on whether the near field communication antenna detects the near field communication device, e.g. a comparator is configured to perform a comparison between first timing information associated with the series of one or more transitions and second timing information associated with a first predefined series of one or more transitions, and/or e.g. a trigger configured to initiate a predefined action of the device based on the comparison. Similarly to as detailed regarding, monitor 1102, identifier 1104, comparator 1106, and trigger 1108 in FIG. 11, one or more of the exemplary detector, controller, monitor, comparator, and/or trigger may be implemented one or more components of core hardware 208, and thus may be implemented as hardware, software, and/or a combination of hardware and software.

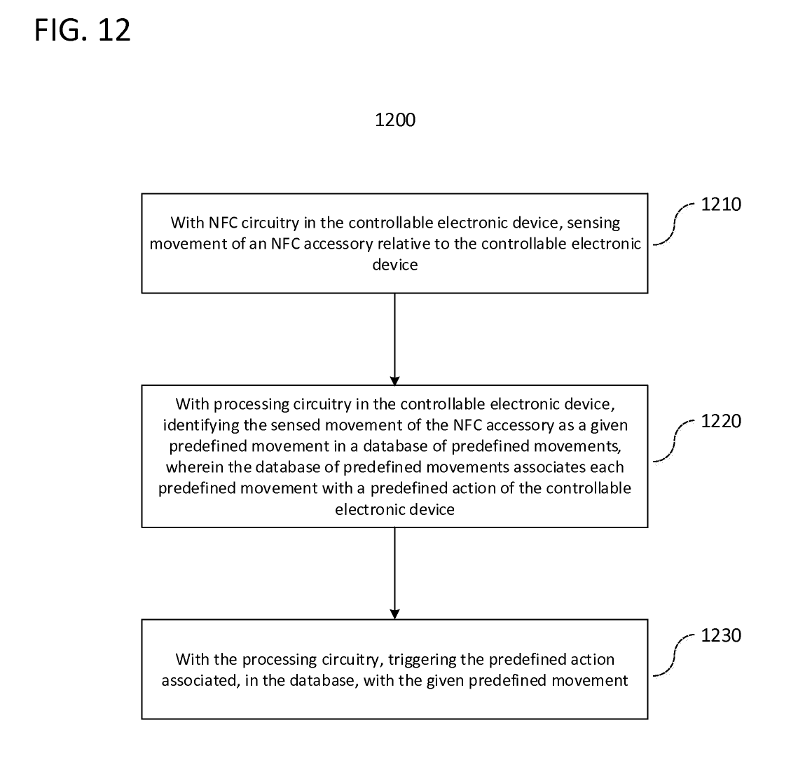

FIG. 12 shows method 1200 for operating a controllable electronic device. In 1210, method 1200 may, with NFC circuitry in the controllable electronic device, sense movement of an NFC accessory relative to the controllable electronic device. Method 1200 may then, with processing circuitry in the controllable electronic device, identify the sensed movement of the NFC accessory as a given predefined movement in a database of predefined movements, wherein the database of predefined movements associates each predefined movement with a predefined action of the controllable electronic device in 1220. In 1230, method 1200 may, with the processing circuitry, trigger the predefined action associated, in the database, with the given predefined movement.

In further exemplary aspects of the disclosure, one or more of methods 900, 1000, or 1200 may be associated with features detailed regarding any one or more of FIGS. 1-9, and may be accordingly configured to implement functionality detailed with respect thereto. This disclosure is considered demonstrative in nature, and accordingly any such combinations between one or aspects of this disclosure detailed herein are considered to be fully embraced.

The implementation of enhanced NFC-based smart device control as detailed herein may be used to trigger a number of different smart device operations based on the variety of unique movements a user may perform with an NFC accessory. The smart device may record time stamps representing points in time in which the NFC accessory enters and exits the NFC field range, thereby defining a digital waveform. The smart device may then compare the recorded digital waveform against a waveform database in order to determine whether the performed movement has been pre-configured by a user or manufacturer to trigger a predefined smart device operation. The smart device may then perform the associated predefined smart device operation, such as through use of an NFC controller.

The enhanced NFC-based smart device control may also be utilized to trigger certain operation states directly based on NFC_Detection_Active or NFC_Detection_Inactive state, such as toggling uppercase/lowercase text entry, scrolling on a virtually displayed page, or copy/paste operations.

Although the implementations described herein have been detailed as involving a single NFC accessory associated with two states (NFC_Detection_Active and NFC_Detection_Inactive), it is appreciated that similar approaches may be expanded to operate with multiple NFC accessories. For example, a user may equip two or more NFC accessories and define NFC movements based on digital waveforms for each NFC accessory. A user may consequently define further movements based on the NFC detection state of each NFC accessory.

In addition to performing predefined smart device operations, NFC accessories may be used similarly to as detailed above to support other user multimedia operations, such as playing a virtual game on a smart device. Various NFC movements may be defined and configured to trigger certain operations within the virtual game, such as to move a virtual avatar within a game or perform a series of actions within the virtual game. The approaches detailed above regarding triggering certain operation states directly based on NFC detection state may additionally be utilized, such as triggering a virtual avatar to perform a running action movement when an NFC accessory enters into the NFC field range (NFC_Detection_Active state) and to perform a walking/default action movement when the NFC accessory exits the NFC field range (NFC_Detection_Inactive state).

Similarly, while sections of this disclosure have focused on controlling a smart device, it is appreciated that any number of controllable devices may be similarly operated utilizing one or more features detailed herein. It is understood that the implementations detailed herein may be applicable to any number of handheld and/or portable devices that are NFC-capable, such as any number of cellular phones, laptops, tablets, keyboards, computer mice, or any such device capable of receiving user input. Furthermore, it is understood that the applications are not limited to portable and/or handheld devices, and e.g. may be applied to stationary devices including personal computers, entertainment systems, home security systems (including e.g. locking and/or door mechanisms), and any number of controllable consumer appliances and/or devices.

The following examples pertain to further aspects of the disclosure:

Example 1 is a device. The device includes a near field communication antenna configured to detect an external near field communication device, and a processor configured to detect a change in detection state of the device from a first detection state to a second detection state, wherein the change in detection state of the device is based on whether the near field communication antenna detects the external near field communication device, determine a duration of a first time period during which the device remains in the second detection state, and trigger a predefined action of the device based on at least the duration of the first time period.

In Example 2, the subject matter of Example 1 can optionally include wherein the first time period is associated with a performed series of one or more transitions in detection state of the device and the predefined action is associated with a predefined series of one or more transitions in detection state of the device, and wherein the processor is further configured to determine whether the performed series of one or more transitions matches with the predefined series of one or more transitions based on at least the duration of the first time period.

In Example 3, the subject matter of Example 2 can optionally include wherein the processor is configured to trigger the predefined action of the device if the performed series of one or more transitions matches with the predefined series of one or more transitions based on at least the duration of the first time period.

In Example 4, the subject matter of Example 3 can optionally include wherein the processor is configured to trigger the predefined action of the device if the performed series of one or more transitions matches with the predefined series of one or more transitions based on at least the duration of the first time period and the duration of a time period associated with the predefined series of one or more transitions.

In Example 5, the subject matter of Example 2 can optionally include wherein the processor is further configured to detect a change in detection state of the device from the second detection state to the first detection state after the first time period, determine a duration of a second time period occurring after the first time period during which the device remains in the first detection state, and determine whether the performed series of one or more transitions matches with the predefined series of one or more transitions based on at least the duration of the first time period and the duration of the second time period.

In Example 6, the subject matter of Example 2 can optionally include wherein the duration of the first time period is based on a first transition time when the detection state of the device changes from the first detection state to the second detection state.

In Example 7, the subject matter of Example 6 can optionally include wherein the processor is configured to determine a timestamp indicating the time of the first transition time.

In Example 8, the subject matter of Example 6 can optionally include wherein the duration of the first time period is further based on a second transition time when the detection state of the device changes from the second state to the first detection state.

In Example 9, the subject matter of Example 2 can optionally include wherein the performed series of one or more transitions is based on a spatial movement pattern of the external near field communication device relative to the device.

In Example 10, the subject matter of Example 2 can optionally include wherein the performed series of one or more transitions includes a first plurality of transitions in detection state of the device.

In Example 11, the subject matter of Example 10 can optionally include wherein the processor is configured to trigger the predefined action of the device based on timing information associated with the first plurality of transitions.

In Example 12, the subject matter of Example 11 can optionally include wherein the timing information associated with the first plurality of transitions includes at least the duration of the first time period.

In Example 13, the subject matter of Example 12 can optionally include wherein the timing information associated with the first plurality of transitions includes one or more further durations.

In Example 14, the subject matter of Example 12 can optionally include wherein the duration of the first time period is the duration of time between a first transition and a second transition of the first plurality of transitions.

In Example 15, the subject matter of Example 10 can optionally include wherein the predefined series of one or more transitions includes a second plurality of transitions, and wherein the processor is configured to trigger the predefined action of the device based on timing information associated with the first plurality of transitions and timing information associated with the second plurality of transitions.

In Example 16, the subject matter of Example 15 can optionally include wherein the processor is configured to trigger the predefined action of the device based on whether the timing information associated with the first plurality of transitions matches the timing information associated with the second plurality of transitions.

In Example 17, the subject matter of Example 16 can optionally include wherein the processor is configured to determine whether the timing formation associated with the first plurality of transitions matches the timing information associated with the second plurality of transitions based on fuzzy logic.

In Example 18, the subject matter of Example 1 can optionally include wherein the duration of the first time period is based on a first transition time when the detection state of the device changes from the first detection state to the second detection state.

In Example 19, the subject matter of Example 18 can optionally include wherein the duration of the first time period is further based on a second transition time when the detection state of the device changes from the second state to the first detection state.

In Example 20, the subject matter of Example 1 can optionally include wherein the processor is further configured to detect a change in detection state of the device from the second detection state to the first detection state after the first time period, determine a duration of a second time period occurring after the first time period during which the device remains in the first detection state, and trigger the predefined action of the device based on at least the duration of the first time period and the duration of the second time period.

In Example 21, the subject matter of Example 20 can optionally include wherein the processor is configured to trigger the predefined action of the device based on at least the duration of the first time period and the duration of the second time period by comparing the duration of the first time period and the duration of the second time period to one or more duration thresholds, wherein the one or more duration thresholds are associated with a predefined series of one or more transitions in the detection state of the device between the first detection state and the second detection state.

In Example 22, the subject matter of Example 20 or 21 can optionally include wherein the processor is configured to trigger the predefined action of the device if the duration of the first time period and the duration time period match with the one or more duration thresholds.

In Example 23, the subject matter of Example 21 can optionally include wherein the predefined series of one or more transitions is associated with the predefined action of the device.

In Example 24, the subject matter of Example 1 can optionally include wherein the processor is further configured to determine durations of one or more further time periods during which the device remains in the first detection state or the second detection state, and trigger the predefined action of the device based on the duration of the first time period and the durations of the one or more further time periods.

In Example 25, the subject matter of Example 24 can optionally include wherein the processor is configured to trigger a predefined action of the device by comparing the duration of the first time period and the one or more further time periods to at least one predefined duration threshold, and triggering the predefined action of the device based on the comparison.

In Example 26, the subject matter of Example 25 can optionally include wherein the at least one predefined duration threshold is associated with a predefined series of one or more transitions in the detection state of the device.

In Example 27, the subject matter of Example 1 can optionally include wherein the processor is configured to trigger a predefined action of the device by comparing the duration of the first time period to at least one predefined duration threshold, and triggering the predefined action based on the comparison.

In Example 28, the subject matter of Example 27 can optionally include wherein the at least one predefined duration threshold is associated with a predefined series of one or more transitions in the detection state of the device.

In Example 29, the subject matter of Example 28 can optionally include wherein the at least one predefined duration threshold is the duration in time between a first transition and a second transition in the predefined series of one or more transitions.

In Example 30, the subject matter of Example 1 can optionally further include a memory configured to store identification information, and wherein the processor is configured to trigger the predefined action of the device further based on whether identification information of the external near field communication device matches the identification information stored in the memory.

In Example 31, the subject matter of Example 1 can optionally include wherein the first detection state is a detection state in which the external near field communication device is not detected by the near field communication antenna, and wherein the second detection state is a detection state in which the external near field communication device is detected by the near field communication antenna.

In Example 32, the subject matter of Example 1 can optionally include wherein the first detection state is a detection state in which the external near field communication device is detected by the near field communication antenna, and wherein the second detection state is a detection state in which the external near field communication device is not detected by the near field communication antenna.

In Example 33, the subject matter of Example 1 can optionally include wherein the external near field communication device is located on the finger of a user.

Example 32 is a device. The device includes a near field communication antenna configured to detect an external near field communication device. The device further includes a monitor configured to monitor a series of one or more transitions in a detection state of the device between a first detection state and a second detection state based on whether the near field communication antenna detects the near field communication device, a comparator configured to perform a comparison between first timing information associated with the series of one or more transitions and second timing information associated with a first predefined series of one or more transitions, and a trigger configured to initiate a predefined action of the device based on the comparison.

In Example 35, the subject matter of Example 34 can optionally include wherein the predefined series of one or more transitions is based on a spatial movement pattern of the external near field communication device relative to the device.

In Example 36, the subject matter of Example 34 can optionally include wherein the trigger is configured to initiate the predefined action if the first timing information matches the second timing information.

In Example 37, the subject matter of Example 36 can optionally include wherein the comparator is configured to determine if the first timing information matches the second timing information based on fuzzy logic.

In Example 38, the subject matter of Example 34 can optionally include wherein the comparator is further configured to compare the first timing information with third timing information associated with a second predefined series of one or more transitions, and wherein the trigger is further configured to initiate a further predefined action of the device if the first timing information matches the third timing information.

In Example 39, the subject matter of Example 34 can optionally further include a memory configured to store the second timing information and third timing information.

In Example 40, the subject matter of Example 39 can optionally include wherein the memory is further configured to store information associating the second timing information with the first predefined series of one or more transitions and information associating the third timing information with the second predefined series of one or more transitions.

In Example 41, the subject matter of Example 34 can optionally include wherein the first predefined series of one or more transitions is associated with the predefined action of the device, and wherein the second predefined series of one or more transitions is associated with the further predefined action.

In Example 42, the subject matter of Example 34 can optionally include wherein the first timing information associated with the series of one or more transitions includes a first plurality of timestamps.

In Example 43, the subject matter of Example 42 can optionally include wherein the second timing information associated with the predefined series of one or more transitions includes a second plurality of time stamps, and wherein the comparator is configured to perform the comparison between the first timing information and the second timing information by comparing the first plurality of time stamps with the second plurality of time stamps.

In Example 44, the subject matter of Example 34 can optionally include wherein the first timing information associated with the series of one or more transitions include a first set of one or more durations.

In Example 45, the subject matter of Example 44 can optionally include wherein the second timing information associated with the predefined series of one or more transitions includes a second set of one or more durations, and wherein the comparator is configured to perform the comparison between the first timing information and the second timing information by comparing the first set of one or more durations with the second set of one or more durations.

In Example 46, the subject matter of Example 34 can optionally include wherein the first predefined series of one or more transitions is associated with the predefined action of the device.

In Example 47, the subject matter of Example 34 can optionally further include a memory configured to store the second timing information.

In Example 48, the subject matter of Example 47 can optionally include wherein the first predefined series of one or more transitions is associated with the predefined action of the device, and wherein the memory is further configured to store information associating the first predefined series of one or more transitions with the predefined action of the device.

In Example 49, the subject matter of Example 34 can optionally include wherein the first timing information and second timing information each include one or more timestamps indicating a transition time between the first detection state and the second detection state, and wherein the comparator is configured to perform the comparison by comparing the one or more timestamps.

In Example 50, the subject matter of Example 49 can optionally include wherein the trigger is configured to initiate the predefined action of the device if the one or more timestamps of the first timing information match the one or more timestamps of the second timing information.

In Example 51, the subject matter of Example 49 can optionally further include a memory configured to store the one or more timestamps of the second timing information.

In Example 52, the subject matter of Example 51 can optionally include wherein the memory is further configured to store information associating the predefined action with the first predefined series of one or more transitions.

In Example 53, the subject matter of Example 51 can optionally include wherein the information associating the predefined action with the predefined series of one or more transitions is configurable by a user.

In Example 54, the subject matter of Example 34 can optionally further include an identifier configured to determine identification information of the external near field communication device, and wherein the trigger is configured to initiate the predefined action of the device further based on the identification information of the external near field communication device.

In Example 55, the subject matter of Example 1 can optionally include wherein the comparator is configured to compare the identification of external near field communication device with identification information stored in a memory.

In Example 56, the subject matter of Example 34 can optionally include wherein the comparator is configured to perform the comparison in real time.

In Example 57, the subject matter of Example 34 can optionally include wherein the first detection state is a detection state in which the external near field communication device is not detected by the near field communication antenna, and wherein the second detection state is a detection state in which the external near field communication device is detected by the near field communication antenna.

In Example 58, the subject matter of Example 34 can optionally include wherein the first detection state is a detection state in which the external near field communication device is detected by the near field communication antenna, and wherein the second detection state is a detection state in which the external near field communication device is not detected by the near field communication antenna.

In Example 59, the subject matter of Example 34 can optionally include wherein the external near field communication device is located on the finger of a user.

In Example 60, the subject matter of Example 34 can optionally include wherein the comparator is configured to perform the comparison using fuzzy logic.

Example 61 is a method for controlling a device. The method includes monitoring a change in detection state of the device from a first detection state to a second detection state, wherein the change in detection state of the smart phone is based on whether a near field communication antenna of the device detects an external near field communication device, determining a duration of a first time period during which the device remains in the second detection state, and triggering a predefined action of the device based on at least the duration of the first time period.

In Example 62, the subject matter of Example 61 can optionally include wherein the first time period is associated with a performed series of one or more transitions in detection state of the device and the predefined action is associated with a predefined series of one or more transitions in detection state of the device, and further including determining whether the performed series of one or more transitions matches with the predefined series of one or more transitions based on at least the duration of the first time period.

In Example 63, the subject matter of Example 62 can optionally include wherein the triggering the predefined action of the device includes triggering the predefined action of the device if the performed series of one or more transitions matches with the predefined series of one or more transitions based on at least the duration of the first time period.

In Example 64, the subject matter of Example 63 can optionally include wherein the triggering the predefined action of the device includes triggering the predefined action of the device if the performed series of one or more transitions matches with the predefined series of one or more transitions based on at least the duration of the first time period and the duration of a time period associated with the predefined series of one or more transitions.

In Example 65, the subject matter of Example 62 can optionally further include monitoring a change in detection state of the device from the second detection state to the first detection state, determining a duration of a second time period occurring after the first time period during which the device remains in the first detection state, and determining whether the performed series of one or more transitions matches with the predefined series of one or more transitions based on at least the duration of the first time period and the duration of the second time period.

In Example 66, the subject matter of Example claim can optionally include, wherein the duration of the first time period is based on a first transition time when the detection state of the device changes from the first detection state to the second detection state.

In Example 67, the subject matter of Example 66 can optionally further include recording a timestamp indicating the time of the first transition time.

In Example 68, the subject matter of Example 66 can optionally include wherein the duration of the first time period is further based on a second transition time when the detection state of the device changes from the second state to the first detection state.

In Example 69, the subject matter of Example 61 can optionally further include determining the duration of the first time period based on a first transition time when the detection state of the device changes from the first detection state to the second detection state.

In Example 70, the subject matter of Example 69 can optionally further include determining the duration of the first time period based on a second transition time when the detection state of the device changes from the second state to the first detection state.

In Example 71, the subject matter of Example 62 can optionally include wherein the performed series of one or more transitions is associated with a spatial movement pattern of the external near field communication device relative to the device.

In Example 72, the subject matter of Example 62 can optionally include wherein the performed series of one or more transitions includes a first plurality of transitions in detection state of the device.

In Example 73, the subject matter of Example 72 can optionally include wherein the processor is configured to trigger the predefined action of the device based on timing information associated with the first plurality of transitions.

In Example 74, the subject matter of Example 73 can optionally include wherein the timing information associated with the first plurality of transitions includes at least the duration of the first time period.

In Example 75, the subject matter of Example 74 can optionally include wherein the timing information associated with the first plurality of transitions further includes one or more further durations.

In Example 76, the subject matter of Example 74 can optionally include wherein the duration of the first time period is the duration of time between a first transition and a second transition of the first plurality of transitions.

In Example 77, the subject matter of Example 72 can optionally include wherein the predefined series of one or more transitions includes a second plurality of transitions, and wherein the triggering the predefined action of the device includes triggering the predefined action of the device based on timing information associated with the first plurality of transitions and timing information associated with the second plurality of transitions.

In Example 78, the subject matter of Example 77 can optionally further include determining whether the timing formation associated with the first plurality of transitions matches the timing information associated with the second plurality of transitions based on fuzzy logic.

In Example 79, the subject matter of Example 61 can optionally further include monitoring a change in detection state of the device from the second detection state to the first detection state after the first time period, determining a duration of a second time period occurring after the first time period during which the device remains in the first detection state, and triggering the predefined action of the device based on at least the duration of the first time period and the duration of the second time period.

In Example 80, the subject matter of Example 79 can optionally include wherein the triggering the predefined action of the device based on at least the duration of the first time period and the duration of the second time period includes comparing the duration of the first time period and the duration of the second time period to one or more duration thresholds, wherein the one or more duration thresholds are associated with a predefined series of one or more transitions in the detection state of the device between the first detection state and the second detection state.

In Example 81, the subject matter of Example 79 or 80 can optionally further include triggering the predefined action of the device if the duration of the first time period and the duration of the second period match with one or more duration thresholds.

In Example 82, the subject matter of Example 80 can optionally include wherein the predefined series of one or more transitions is associated with the predefined action of the device.

In Example 83, the subject matter of Example 61 can optionally further include determining durations of one or more further time periods during which the device remains in the first detection state or the second detection state, and triggering the predefined actin of the device based on the duration of the first time period and the durations of the one or more further time periods.

In Example 84, the subject matter of Example 83 can optionally include wherein the triggering the predefined action of the device based on the duration of the first time period and the durations of the one or more further time periods includes comparing the duration of the first time period and the one or more further time periods to at least one predefined duration threshold, and triggering the predefined action of the device based on the comparison.

In Example 85, the subject matter of Example 84 can optionally include wherein the at least one predefined duration threshold is associated with a predefined series of one or more transitions in the detection state of the device.

In Example 86, the subject matter of Example 61 can optionally include wherein the triggering a predefined action of the device includes comparing the duration of the first time period to at least one predefined duration threshold, and triggering the predefined action based on the comparison.

In Example 87, the subject matter of Example 86 can optionally include wherein the at least one predefined duration threshold is associated with a predefined series of one or more transitions in the detection state of the device.

In Example 88, the subject matter of Example 87 can optionally include wherein the at least one predefined duration threshold is the duration in time between a first transition and a second transition in the predefined series of one or more transitions.

In Example 89, the subject matter of Example 61 can optionally include wherein the triggering the predefined action of the device includes triggering the predefined action of the device further based on whether identification information of the external near field communication device matches identification information stored in a memory.

In Example 90, the subject matter of Example 61 can optionally include wherein the first detection state is a detection state in which the external near field communication device is not detected by the near field communication antenna, and wherein the second detection state is a detection state in which the external near field communication device is detected by the near field communication antenna.

In Example 91, the subject matter of Example 61 can optionally include wherein the first detection state is a detection state in which the external near field communication device is detected by the near field communication antenna, and wherein the second detection state is a detection state in which the external near field communication device is not detected by the near field communication antenna.

In Example 92, the subject matter of Example 61 can optionally include wherein the external near field communication device is located on the finger of a user.

Example 93 is a device. The device includes a near field communication antenna configured to detect an external near field communication device, and a processor configured to detect a transition in detection state of the device from a first detection state to a second detection state, wherein the transition in detection state of the device is based on whether the near field communication antenna detects the external near field communication device, control the device to operate according to a first operation mode during a first time period before the transition in which the device remains in the first detection state, and control the device to operate according to a second operation mode during a second time period after the transition once the device transitions from the first detection state to the second detection state.

In Example 94, the subject matter of Example 93 can optionally include wherein the processor is configured to control the device to operate according to the second operation mode immediately upon detecting the transition in detection state from the first detection state to the second detection state.

In Example 95, the subject matter of Example 93 can optionally include wherein the processor is further configured to detect a further transition in detection state of the device from the second detection state to the first detection state, and control the device to operate according to the first operation mode during a third time period after the further transition.

In Example 96, the subject matter of Example 95 can optionally include wherein the processor is configured to control the device to operate according to the first operation mode for the entire duration of the first time period.

In Example 97, the subject matter of Example 95 or 96 can optionally include wherein the processor is configured to control the device to operate according to the second operation mode for the entire duration of the second time period.

In Example 98, the subject matter of Example 93 can optionally include wherein the processor is configured to control the device to operate according to the first operation mode for the entire duration of the first time period.

In Example 99, the subject matter of Example 93 can optionally include wherein the first operation mode is a first type of character text entry and the second operation mode is a second type of character text entry different from the first type of character text entry.

In Example 100, the subject matter of Example 99 can optionally include wherein the first operation mode is uppercase character text entry and the second operation mode is lowercase character text entry, or wherein the first operation mode is lowercase character text entry and the second operation mode is uppercase character text entry.

In Example 101, the subject matter of Example 93 can optionally include wherein the first operation mode is a first type of scrolling operation, and wherein the second operation mode is a second type of scrolling operation different from the first type of scrolling operation.

In Example 102, the subject matter of Example 101 can optionally include wherein the first operation mode is selected from a scrolling type group consisting of a scroll up operation, a scroll down operation, and a no scrolling operation, and wherein the second operation mode is selected from the scrolling type group consisting of a scroll up operation, a scroll down operation, and a no scrolling operation.

In Example 103, the subject matter of Example 93 can optionally include wherein the external near field communication device is located on the finger of a user.

In Example 104, the subject matter of Example 93 can optionally include wherein the processor is further configured to receive first identification information of the external near field communication device, and perform a comparison between the first identification information and second identification information.

In Example 105, the subject matter of Example 104 can optionally include wherein the processor is configured to control the device to operate according to the first operation mode and control the device to operate according to the second operation mode based on the comparison.

In Example 106, the subject matter of Example 105 can optionally include wherein the processor is configured to control the device to operate according to the first operation mode and control the device to operate according to the second operation mode if the first identification information matches the second identification information.

In Example 107, the subject matter of Example 104 can optionally further include a memory configured to store the second identification information.

In Example 108, the subject matter of Example 107 can optionally include wherein the memory is configured to store further identification information, and wherein the device is configured to perform a comparison between the first identification information and the further identification information.

In Example 109, the subject matter of Example 108 can optionally include wherein the processor is configured to control the device to operate according to the first operation mode and control the device to operate according to the second operation mode if the first identification information matches the further identification information.

In Example 110, the subject matter of Example 93 can optionally include wherein the first detection state corresponds to the near field communication antenna being unable to detect the external near field communication device.

In Example 111, the subject matter of Example 93 can optionally include wherein the second detection state corresponds to the near field communication antenna being unable to detect the external near field communication device.

Example 112 is a method for controlling a device. The method includes detecting a transition in detection state of the device from a first detection state to a second detection state, wherein the detection state of the device is based on whether a near field communication antenna of the device detects an external near field communication device, controlling the device to operate according to a first operation mode during a first time period before the transition in which the device remains in the first detection state, and controlling the device to operate according to a second operation mode during a second time period after the transition once the device transitions from the first detection state to the second detection state.

In Example 113, the subject matter of Example 112 can optionally include wherein the controlling the device to operate according to the second operation mode includes controlling the device to operate according to the second operation mode immediately upon detecting the transition in detection state from the first detection state to the second detection state.

In Example 114, the subject matter of Example 112 can optionally further include detecting a further transition in detection state of the device from the second detection state to the first detection state, and controlling the device to operate according to the first operation during a third time period after the further transition.

In Example 115, the subject matter of Example 114 can optionally further include controlling the device to operate according to the first operation mode for the entire duration of the first time period.

In Example 116, the subject matter of Example 114 or 115 can optionally further include controlling the device to operate according to the second operation mode for the entire duration of the second time period.

In Example 117, the subject matter of Example 112 can optionally further include controlling the device to operate according to the first operation mode for the entire duration of the first time period.

In Example 118, the subject matter of Example 112 can optionally include wherein the first operation mode is a pre-defined operation triggered by the device, and wherein the second operation mode is a different pre-defined operation triggered by the device.

In Example 119, the subject matter of Example 112 can optionally include wherein the first operation mode is a first type of character text entry and the second operation mode is a second type of character text entry different from the first type of character text entry.

In Example 120, the subject matter of Example 119 can optionally include wherein the first operation mode is uppercase character text entry and the second operation mode is lowercase character text entry, or wherein the first operation mode is lowercase character text entry and the second operation mode is uppercase character text entry.

In Example 121, the subject matter of Example 112 can optionally include wherein the first operation mode is a first type of scrolling operation, and wherein the second operation mode is a second type of scrolling operation different from the first type of scrolling operation.

In Example 122, the subject matter of Example 121 can optionally include wherein the first operation mode is selected from a scrolling type group consisting of a scroll up operation, a scroll down operation, and a no scrolling operation, and wherein the second operation mode is selected from the scrolling type group consisting of a scroll up operation, a scroll down operation, and a no scrolling operation.

In Example 123, the subject matter of Example 112 can optionally include wherein the external near field communication device is located on the finger of a user.

In Example 124, the subject matter of Example 112 can optionally further include receiving first identification information of the external near field communication device, and performing a comparison between the first identification information and second identification information.

In Example 125, the subject matter of Example 124 can optionally include wherein the controlling the device to operate according to the first operation mode and the controlling the device to operate according to the second operation mode is based on the comparison.

In Example 126, the subject matter of Example 125 can optionally include wherein the controlling the device to operate according to the first operation mode and controlling the device to operate according to the second operation mode includes controlling the device to operate according to the first operation mode and controlling the device to operate according to the second operation mode if the first identification information matches the second identification information.

In Example 127, the subject matter of Example 124 can optionally further include storing the second identification information is stored on a memory of the device.

In Example 128, the subject matter of Example 127 can optionally further include storing further identification information on the memory, and performing a comparison between the first identification information and the further identification information.

In Example 129, the subject matter of Example 128 can optionally include wherein the controlling the device to operate according to the first operation mode and controlling the device to operate according to the second operation mode includes controlling the device to operate according to the first operation mode and controlling the device to operate according to the second operation mode if the first identification information matches the further identification information.

In Example 130, the subject matter of Example 112 can optionally include wherein the first detection state corresponds to the near field communication antenna being unable to detect the external near field communication device.

In Example 131, the subject matter of Example 112 can optionally include wherein the second detection state corresponds to the near field communication antenna being unable to detect the external near field communication device.

Example 132 is a device. The device includes a near field communication antenna configured to detect an external near field communication device. The device also include a monitor, a comparator, and a trigger. The monitor is configured to monitor a series of one or more transitions in a detection state of the device between a first detection state and a second detection state based on whether the near field communication antenna detects the near field communication device. The comparator is configured to perform a comparison between first timing information associated with the series of one or more transitions and second timing information associated with a first predefined series of one or more transitions. The trigger is configured to initiate a predefined action of the device based on the comparison.

Example 133 is a device. The device includes a near field communication antenna, a monitor, a detector, a determiner, and a trigger. The near field communication antenna configured to detect an external near field communication device. The detector is configured to change a detection state of the device from a first detection state to a second detection state based on whether the near field communication antenna detects the near field communication device. The determiner is configured to determine a duration of a first time period during which the device remains in the second detection state. The trigger is configured to initiate a predefined action of the device based on at least the duration of the first time period.

Example 134 is a device. The device includes a near field communication antenna, a detector, and a controller. The near field communication antenna is configured to detect an external near field communication device. The detector is configured to change a transition in detection state of the device from a first detection state to a second detection state, wherein the detection state of the device is based on whether the near field communication antenna detects the external near field communication device. The controller is configured to control the device to operate according a first operation mode during a first time period before the transition in which the device remains in the first detection state and control the device to operate according to a second operation mode during a second time period after the transition once the device transitions from the first detection state to the second detection state.

Example 135 is a method of operating a controllable electronic device. The method includes with NFC circuitry in the controllable electronic device, sensing movement of an NFC accessory relative to the controllable electronic device, with processing circuitry in the controllable electronic device, identifying the sensed movement of the NFC accessory as a given predefined movement in a database of predefined movements, wherein the database of predefined movements associates each predefined movement with a predefined action of the controllable electronic device, and with the processing circuitry, triggering the predefined action associated, in the database, with the given predefined movement.

In Example 136, the subject matter of Example 135 can optionally include wherein the sensing movement of the NFC accessory relative to the controllable electronic device includes sensing user input.

In Example 137, the subject matter of Example 135 can optionally include wherein the sensing movement of the NFC accessory relative to the controllable electronic device includes sensing the NFC accessory entering a detection range of the NFC circuitry in the controllable electronic device.

In Example 138, the subject matter of Example 137 can optionally include wherein the sensing movement of the NFC accessory relative to the controllable electronic device includes sensing the NFC accessory leaving the detection range of the NFC circuitry in the controllable electronic device.

In Example 139, the subject matter of Example 137 can optionally further include, with the processing circuitry in the controllable electronic device, calculating a detected duration of time during which the NFC accessory remains within the detection range of the NFC circuitry in the controllable electronic device.

In Example 140, the subject matter of Example 139 can optionally include wherein the identifying the sensed movement of the NFC accessory as a given predefined movement in a database of predefined movements includes comparing the detected duration of time to a duration of time associated with at least one of the predefined movements in the database of predefined movements.

In Example 141, the subject matter of Example 139 can optionally include wherein the sensing the NFC accessory entering a detection range of the NFC circuitry in the controllable electronic device includes detecting the NFC accessory crossing a detection threshold of the NFC circuitry.

In Example 142, the subject matter of Example 137 can optionally include wherein the sensing the NFC accessory entering a detection range of the NFC circuitry in the controllable electronic device includes detecting the NFC accessory crossing a detection threshold of an NFC antenna of the controllable electronic device.

In Example 143, the subject matter of Example 135 can optionally include wherein the controllable electronic device includes a handheld electronic device having a display on a front side and having an NFC antenna disposed on a back side.

In Example 144, the subject matter of Example 135 can optionally include wherein the external NFC accessory is disposed on a user's finger.

In Example 145, the subject matter of Example 135 can optionally include wherein the identifying the sensed movement of the NFC accessory as a given predefined movement in a database of predefined movements includes identifying that the sensed movement is substantially similar to the given predefined movement.

In Example 146, the subject matter of Example 145 can optionally include wherein the identifying the sensed movement of the NFC accessory as a given predefined movement in a database of predefined movements further includes identifying that the sensed movement is not substantially similar to one or more other predefined movements of the database of predefined movements.

In Example 147, the subject matter of Example 145 can optionally include wherein the identifying that the sensed movement is substantially similar to the given predefined movement includes utilizing fuzzy logic to identify whether or not the sensed movement is substantially similar to the given predefined movement.

In Example 148, the subject matter of Example 135 can optionally include wherein the identifying the sensed movement of the NFC accessory as a given predefined movement in a database of predefined movements includes determining a sensed waveform based on the sensed movement.

In Example 149, the subject matter of Example 148 can optionally include wherein the identifying the sensed movement of the NFC accessory as a given predefined movement in a database of predefined movements includes comparing the sensed waveform with one or more defined waveforms associated with the predefined movements in the database of predefined movements.

In Example 150, the subject matter of Example 148 can optionally further include, with a memory in the controllable electronic device, storing the database of predefined movements.

In Example 151, the subject matter of Example 150 can optionally include wherein the storing the database of predefined movements includes storing a designated waveform corresponding to each of the predefined movements in the memory.

In Example 152, the subject matter of Example 151 can optionally include wherein the identifying the sensed movement of the NFC accessory as a given predefined movement in a database of predefined movements includes comparing the sensed waveform with the designated waveforms corresponding to one or more of the predefined movements.

In Example 153, the subject matter of Example 135 can optionally further include with a memory in the controllable electronic device, storing the database of predefined movements.

In Example 154, the subject matter of Example 153 can optionally include wherein the storing the database of predefined movements includes storing a designated waveform corresponding to each of the predefined movements in the memory.

In Example 155, the subject matter of Example 149 can optionally include wherein the identifying the sensed movement of the NFC accessory as a given predefined movement in a database of predefined movements includes comparing the sensed waveform with the designated waveforms corresponding to one or more of the predefined movements.

In Example 156, the subject matter of Example 145 can optionally include wherein the identifying the sensed movement of the NFC accessory as a given predefined movement in a database of predefined movements includes identifying that the sensed movement is substantially similar to the given predefined movement based on timing information associated with the sensed movement and timing information associated with the predefined movements of the database of predefined movements.

In Example 157, the subject matter of Example 156 can optionally include wherein the timing information associated with the sensed movement and timing information associated with the predefined movements of the database of predefined movements includes one or more timestamps or one or more time period durations.

In Example 158, the subject matter of Example 157 can optionally include wherein the one or more timestamps include timepoints when the NFC accessory enters or leaves a detection range of the NFC circuitry.

In Example 159, the subject matter of Example 157 can optionally include wherein the one or more time periods durations include time windows in which the NFC accessory is within the detection range of the NFC circuitry or outside of the detection range of the NFC circuitry.

In Example 160, the subject matter of Example 135 can optionally include wherein the identifying the sensed movement of the NFC accessory as a given predefined movement in a database of predefined movements includes comparing timing information of the sensed movement to timing information of the predefined movements.

In Example 161, the subject matter of Example 160 can optionally include wherein the comparing timing information of the sensed movement to timing information of the predefined movements includes comparing one or more timestamps associated with the sensed movement to one or more timestamps associated with one or more of the predefined movements.

In Example 162, the subject matter of Example 161 can optionally include wherein the sensing movement of the NFC accessory relative to the controllable electronic device includes sensing one or detection timepoints at which the NFC accessory enters or leaves a detection range of the NFC circuitry.

In Example 163, the subject matter of Example 162 can optionally include wherein the one or more timestamps associated with the sensed movement are based on one or more of the one or more of the detection timepoints.

In Example 164, the subject matter of Example 135 can optionally include wherein the sensing movement of the NFC accessory relative to the controllable electronic device includes sensing one or detection timepoints in which NFC accessory enters or leaves a detection range of the NFC circuitry.

In Example 165, the subject matter of Example 164 can optionally include wherein the, identifying the sensed movement of the NFC accessory as a given predefined movement in a database of predefined movements includes deriving a sensed waveform based on the one or more detection timepoints.

In Example 166, the subject matter of Example 165 can optionally include wherein the identifying the sensed movement of the NFC accessory as a given predefined movement in a database of predefined movements includes comparing the sensed waveform to designated waveforms corresponding to one or more of the predefined movements.

In Example 167, the subject matter of Example 135 can optionally further include, with the NFC circuitry, reading identification information of the NFC accessory.

In Example 168, the subject matter of Example 167 can optionally include wherein the identifying the sensed movement of the NFC accessory as a given predefined movement in a database of predefined movements includes identifying the sensed movement of the NFC accessory as a given predefined movement in a database of predefined movements based on the identification information.

In Example 169, the subject matter of Example 135 can optionally include wherein a first predefined movement of the predefined movements is different from a second predefined movement of the predefined movements.

In Example 170, the subject matter of Example 169, wherein the first predefined movement is associated with a first spatial movement pattern of the of the NFC accessory relative to the controllable electronic device and the second predefined movement is associated with a second spatial movement pattern of the NFC accessory relative to the controllable electronic device.

In Example 171, the subject matter of Example 170 can optionally include wherein the first spatial movement pattern is different than the second spatial movement pattern.

In Example 172, the subject matter of Example 169 can optionally include wherein the first predefined movement is associated with one or more first timepoints when the NFC accessory enters or leaves a detection range of the NFC circuitry and the second predefined movement is associated with one or more second timepoints when the NFC accessory enters or leaves a detection range of the NFC circuitry.

In Example 173, the subject matter of Example 172 can optionally include wherein the one or more first timepoints are different than the one more second timepoints.

In Example 174, the subject matter of Example 135 can optionally include wherein a first predefined movement of the predefined movements is associated with a first predefined action and a second predefined movement of the predefined movements is associated with a second predefined action.

In Example 175, the subject matter of Example 174 can optionally include wherein the first predefined action is different than the second predefined action.

In Example 176, the subject matter of Example 135 can optionally include wherein the sensed movement is associated with one or more sensed timepoints when the NFC accessory enters or leaves a detection range of the NFC circuitry and the given predefined movement is associated with one or more defined timepoints when the NFC accessory enters or leaves a detection range of the NFC circuitry.

In Example 177, the subject matter of Example 176 can optionally include wherein the identifying the sensed movement of the NFC accessory as a given predefined movement in a database of predefined movements includes identifying that the one or more sensed timepoints are substantially similar to the one or more defined timepoints.

In Example 178, the subject matter of Example 177 can optionally include wherein the identifying that the one or more sensed timepoints are substantially similar to the one or more defined timepoints includes utilizing fuzzy logic to identify whether the one or more sensed timepoints are substantially similar to the one or more defined timepoints.

In Example 179, the subject matter of Example 135 can optionally include wherein the processing circuitry includes an application processor, and wherein the triggering the predefined movement associated, in the database, with the given predefined movement includes executing the predefined action with the application processor.

In Example 180, the subject matter of Example 135 can optionally include wherein the controllable electronic device is a portable electronic device.

Example 181 is a device. The device includes a near field communication antenna and a processing circuit. The near field communication antenna is configured to detect an external near field communication device. The processing circuit is configured to monitor a series of one or more transitions in a detection state of the device between a first detection state and a second detection state based on whether the near field communication antenna detects the near field communication device, perform a comparison between first timing information associated with the series of one or more transitions and second timing information associated with a first predefined series of one or more transitions, and initiate a predefined action of the device based on the comparison.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. A method of operating a controllable electronic device, the method comprising:
with NFC circuitry in the controllable electronic device, sensing movement of the NFC accessory relative to the controllable electronic device;
with processing circuitry in the controllable electronic device, identifying the sensed movement of the NFC accessory as a given predefined movement in a database of predefined movements, wherein the database of predefined movements associates each predefined movement with a predefined action of the controllable electronic device; and
with the processing circuitry, triggering the predefined action associated, in the database, with the given predefined movement.

2. The method of claim 1, wherein the identifying the sensed movement of the NFC accessory as a given predefined movement in a database of predefined movements comprises comparing timing information of the sensed movement to timing information of the predefined movements.

3. The method of claim 2, wherein the comparing timing information of the sensed movement to timing information of the predefined movements comprises comparing one or more timestamps associated with the sensed movement to one or more timestamps associated with one or more of the predefined movements.

4. The method of claim 3, wherein the sensing movement of the NFC accessory relative to the controllable electronic device comprises sensing one or detection timepoints at which the NFC accessory enters or leaves a detection range of the NFC circuitry.

5. The method of claim 4, wherein the one or more timestamps associated with the sensed movement are based on one or more of the one or more of the detection timepoints.

6. The method of claim 1, wherein the sensing movement of the NFC accessory relative to the controllable electronic device comprises sensing the NFC accessory entering a detection range of the NFC circuitry in the controllable electronic device.

7. A device comprising:
a near field communication antenna configured to detect an external near field communication device;
a monitor configured to monitor a series of one or more transitions in a detection state of the device between a first detection state and a second detection state based on whether the near field communication antenna detects the near field communication device;
a comparator configured to perform a comparison between first timing information associated with the series of one or more transitions and second timing information associated with a first predefined series of one or more transitions; and
a trigger configured to initiate a predefined action of the device based on the comparison.

8. The device of claim 7, wherein the predefined series of one or more transitions is based on a spatial movement pattern of the external near field communication device relative to the device.

9. The device of claim 7, wherein the trigger is configured to initiate the predefined action if the first timing information matches the second timing information.

10. The method of claim 9, wherein the predefined series of one or more transitions is associated with the predefined action of the device.

11. The device of claim 7, wherein the comparator is further configured to compare the first timing information with third timing information associated with a second predefined series of one or more transitions,
and wherein the trigger is further configured to initiate a further predefined action of the device if the first timing information matches the third timing information.

12. The device of claim 7, further comprising a memory configured to store the second timing information and third timing information.

13. The device of claim 12, wherein the memory is further configured to store information associating the second timing information with the first predefined series of one or more transitions and information associating the third timing information with the second predefined series of one or more transitions.

14. The device of claim 7, wherein the first timing information and second timing information each comprise one or more timestamps indicating a transition time between the first detection state and the second detection state, and wherein the comparator is configured to perform the comparison by comparing the one or more timestamps.

15. The device of claim 7, further comprising an identifier configured to determine identification information of the external near field communication device,
and wherein the trigger is configured to initiate the predefined action of the device further based on the identification information of the external near field communication device.

16. A device comprising:
a near field communication antenna configured to detect an external near field communication device; and
a processor configured to:
detect a transition in detection state of the device from a first detection state to a second detection state, wherein the detection state of the device is based on whether the near field communication antenna detects the external near field communication device;
control the device to operate according to a first operation mode during a first time period before the transition in which the device remains in the first detection state; and
control the device to operate according to a second operation mode during a second time period after the transition once the device transitions from the first detection state to the second detection state.

17. The device of claim 16, wherein the processor is configured to control the device to operate according to the second operation mode immediately upon detecting the transition in detection state from the first detection state to the second detection state.

18. The device of claim 16, wherein the processor is further configured to:
detect a further transition in detection state of the device from the second detection state to the first detection state; and
control the device to operate according to the first operation mode during a third time period after the further transition.

19. The device of claim 16, wherein the first operation mode is a first type of character text entry and the second operation mode is a second type of character text entry different from the first type of character text entry.

20. The device of claim 16, wherein the first operation mode is a first type of scrolling operation, and wherein the second operation mode is a second type of scrolling operation different from the first type of scrolling operation.
